(19) United States
(12) Patent Application Publication
(10) Pub. No.: US 2026/0140905 A1
(43) Pub. Date: May 21, 2026

(54) ELECTRONIC DEVICE AND METHOD WITH NETWORK BACKPLANE STRUCTURE

(71) Applicant: SAMSUNG ELECTRONICS CO., LTD., Suwon-si (KR)

(72) Inventors: Young Jun HONG, Suwon-si (KR); Casey Glenn THIELEN, Mesa, AZ (US); Praveen Koottate FRANCIS, Waltham, MA (US); Byungwoo BANG, Suwon-si (KR); Janghyuk AN, Suwon-si (KR)

(73) Assignee: SAMSUNG ELECTRONICS CO., LTD., Suwon-si (KR)

(21) Appl. No.: 19/210,368

(22) Filed: May 16, 2025

Related U.S. Application Data
(60) Provisional application No. 63/721,054, filed on Nov. 15, 2024.

(30) Foreign Application Priority Data
Dec. 10, 2024 (KR) 10-2024-0182887

(51) Int. Cl. G06F 13/40

(52) U.S. Cl. CPC G06F 13/4022

(57) ABSTRACT

An electronic device includes switches connected to computing devices included in a reference computing board, and first connectors connected to the switches in the reference computing board and grouped into a plurality of groups, wherein among the first connectors, first target connectors grouped into a target group among the plurality of groups are connected to second target connectors grouped into a group mapped to the target group among second connectors included in another computing board mapped to the target group, and one of the computing devices included in the reference computing board is connected to one of computing devices included in the other computing board via the switches, the first target connectors, and the second target connectors.

### CROSS-REFERENCE TO RELATED APPLICATIONS

This application claims the benefit under 35 U.S.C. § 119 (e) of U.S. Provisional Application No. 63/721,054 filed on Nov. 15, 2024 in the U.S. Patent and Trademark Office, and claims the benefit under 35 USC § 119 (a) of Korean Patent Application No. 10-2024-0182887 filed on Dec. 10, 2024 in the Korean Intellectual Property Office, the entire disclosures, all of which, are incorporated herein by reference for all purposes.

### 1. FIELD

The following description relates to an electronic device and method with a network backplane structure.

### 2. DESCRIPTION OF RELATED ART

As the size of applications processed in large-scale computer systems increases, the exchange of information between processors and/or memories may become more frequent. When the performance of an application is limited by input/output (I/O) bandwidth, securing sufficient bandwidth may become difficult. In addition, computing infrastructure equipped with multiple processors and/or memories, along with highly integrated computing structures and connection schemes, may inefficiently connect computing resources.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, an electronic device includes switches connected to computing devices included in a reference computing board, and first connectors connected to the switches in the reference computing board and grouped into a plurality of groups, wherein among the first connectors, first target connectors grouped into a target group among the plurality of groups are connected to second target connectors grouped into a group mapped to the target group among second connectors included in another computing board mapped to the target group, and one of the computing devices included in the reference computing board is connected to one of computing devices included in the other computing board via the switches, the first target connectors, and the second target connectors.

Each of the switches may be connected to each switch on other computing boards via the first connectors and the second connectors, and the switches included in the reference computing board may not be directly connected to each other.

One or more of the first target connectors may be arranged on a first surface of the reference computing board, remaining connectors of the first target connectors may be arranged on a second surface of the reference computing board, and among the switches, a first switch may be arranged closer to the first connectors on the reference computing board than a remaining second switch.

The first connectors may be connected to the second connectors included in the other computing board, based on a predetermined mapping rule that a distance between the reference computing board and the other computing board is less than or equal to a predetermined threshold.

The first switch may be connected to a switch arranged further away from the second connectors than other switches on the other computing board, and the second switch may be connected to a switch arranged closer to the second connectors than the other switches on the other computing board.

Based on a path loss of one or more of the switches, the first connectors, the second connectors, and cables connecting the connectors, the one of the computing devices included in the reference computing board may be connected to the one of the computing devices included in the other computing board such that a total path loss between the one of the computing devices included in the reference computing board and the one of the computing devices included in the other computing board is less than or equal to a predetermined threshold.

Wires connecting the switches and the computing devices, and/or wires connecting the switches and the first connectors, may be determined as a high density interconnect (HDI) trace or a multi-layer board (MLB) trace depending on a path loss per wire length.

In one or more general aspects an electronic device includes switches connected to computing devices included in a reference computing board, and first connectors connected to the switches in the reference computing board and grouped into a plurality of groups, wherein the first connectors grouped into the plurality of groups may be connected to the second connectors included in another computing board in corresponding groups, and one of the computing devices included in the reference computing board may be connected to one of computing devices included in the other computing board via the switches, the first connectors, and the second connectors.

Each of the switches may be connected to each switch on other computing boards via the first connectors and the second connectors, and the switches included in the reference computing board may not be directly connected to each other.

One or more of the first connectors in the same group may be arranged on a first surface of the reference computing board, remaining connectors of the first connectors may be arranged on a second surface of the reference computing board, and among the switches connected to the first connectors, a first switch may be arranged closer to the first connectors on the reference computing board than a remaining second switch.

The first connectors may be connected to the second connectors included in the other computing board, based on a predetermined mapping rule that a distance between the reference computing board and the other computing board is less than or equal to a predetermined threshold.

The first switch may be connected to a switch arranged further away from the second connectors than other switches on the other computing board, and the second switch may be connected to a switch arranged closer to the second connectors than the other switches on the other computing board.

Based on a path loss of one or more of the switches, the first connectors, the second connectors, and cables connecting the connectors, the one of the computing devices included in the reference computing board may be connected to the one of the computing devices included in the other computing board such that a total path loss between the one of the computing devices included in the reference computing board and the one of the computing devices included in the other computing board is less than or equal to a predetermined threshold.

The first connectors may be first target connectors grouped into a target group among the plurality of groups, and the second connectors may be second target connectors grouped into a group mapped to the target group.

In one or more general aspects, a processor-implemented method includes via a connection between a first computing device included in a first computing board and switches included in the first computing board, partitioning data to be transmitted from the first computing device to a second computing device included in a second computing board and transmitting the partitioned data to the switches, via a connection between first target connectors grouped in a target group corresponding to the second computing board among first connectors included in the first computing board and the switches, transmitting the partitioned data from the switches to the first target connectors, and via a connection between the first target connectors and second target connectors grouped into a group mapped to the target group among second connectors included in the second computing board, transmitting the partitioned data together from the first target connectors to the second target connectors, wherein the second target connectors are configured to transmit the partitioned data to the second computing device via switches included in the second computing board.

Each of the switches included in the first computing board may be connected to each switch on second computing boards via the first connectors and the second connectors, and the switches included in the first computing board may not be directly connected to each other.

One or more of the first target connectors in the target group may be arranged on a first surface of the first computing board, remaining connectors of the first target connectors may be arranged on a second surface of the first computing board, and among the switches connected to the first target connectors, a first switch may be arranged closer to the first target connectors on the first computing board than a remaining second switch.

The first connectors may be connected to the second connectors included in the second computing board, based on a predetermined mapping rule that a distance between the first computing board and the second computing board is less than or equal to a predetermined threshold.

The first switch may be connected to a switch arranged further away from the second connectors than the switches included in the second computing board, and the second switch may be connected to a switch arranged closer to the second connectors than the switches included in the second computing board.

Based on a path loss of one or more of the switches, the first connectors, the second connectors, and cables connecting the connectors, the first computing device may be connected to the second computing device included in the second computing board such that a total path loss between the first computing device and the second computing device is less than or equal to a predetermined threshold.

Other features and aspects will be apparent from the following detailed description, the drawings, and the claims.

### BRIEF DESCRIPTION OF THE DRAWINGS

FIGS. 1 and 2 illustrate examples of an electronic device.

FIG. 3 illustrates an example of connections within a computing board.

FIG. 4 illustrates an example of a structure of switches.

FIGS. 5 and 6 illustrate examples of connections of computing devices.

FIGS. 7 and 8 illustrate examples of connections between computing devices, switches, and connectors within a computing board.

FIGS. 9 and 10 illustrate examples of connections of computing boards.

FIG. 11 illustrates an example of a structure of an electronic device.

FIG. 12 illustrates an example of connections of computing boards.

FIG. 13 illustrates an example of a connection of computing boards according to a horizontal structure of an electronic device.

FIG. 14 illustrates an example of a partitioned connection structure of an electronic device.

FIG. 15 illustrates an example of a group of connectors.

FIGS. 16 and 17 illustrate examples of a path loss of a connection structure.

FIGS. 18 and 19 illustrate examples of an arrangement of switches and connectors.

FIG. 20 illustrates an example of a multi-layer wiring.

FIGS. 21 and 22 illustrate examples of connections of multi-layer board (MLB) traces and

high-density interconnect (HDI) traces.

FIG. 23 illustrates an example of connections of a multi-layer wiring structure.

FIG. 24 illustrates an example of a connector array.

FIG. 25 illustrates an example of an arrangement structure of a connector array.

FIG. 26 illustrates an example of a structure of a rack.

FIGS. 27 and 28 illustrate examples of pairs connected between computing boards.

FIGS. 29 to 31 illustrate examples of mapping rules.

FIG. 32 illustrates an example of mapping rules.

FIG. 33 illustrates an example of computing nodes being connected.

FIGS. 34 to 38 illustrate examples of switches being connected while taking path losses into account.

FIG. 39 illustrates an example of an operating method of an electronic device in a bundled connection structure.

FIG. 40 illustrates an example of an operating method of an electronic device in a partitioned connection structure.

Throughout the drawings and the detailed description, unless otherwise described or provided, the same drawing reference numerals may be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on,” “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” to specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application, and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment,” and “one or more examples” has a same meaning as “in one or more embodiments”).

Although terms such as “first,” “second,” and “third,” or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but is used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Hereinafter, embodiments will be described in detail with reference to the accompanying drawings. When describing the examples with reference to the accompanying drawings, like reference numerals refer to like components and a repeated description related thereto will be omitted.

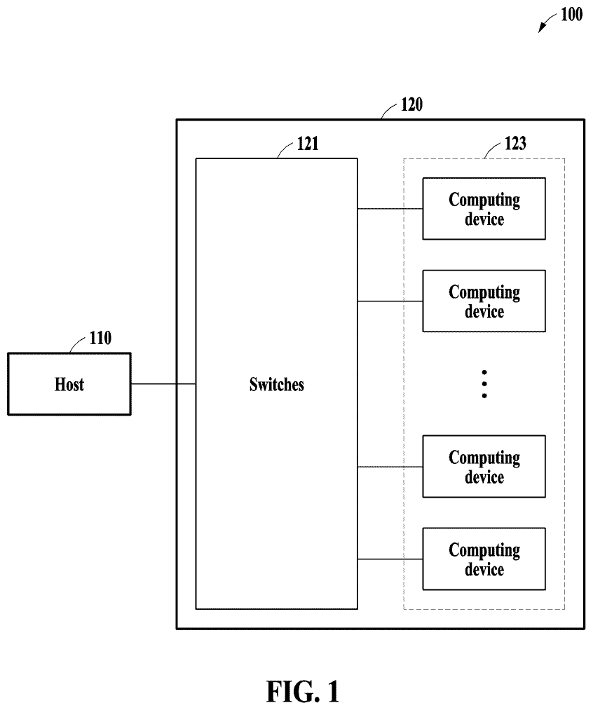

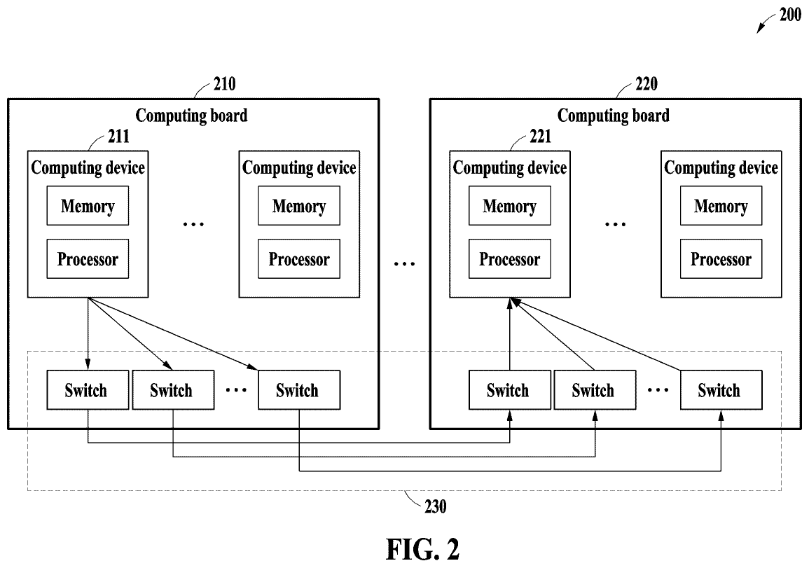

FIGS. 1 and 2 illustrate examples of an electronic device.

Referring to FIG. 1, an electronic device 100 may include a host 110 and a computing board 120. The host 110 may be a device that controls components of the computing board 120, and may, for example, control the transmission of data from one of a plurality of computing devices 123 to another or to one of the computing devices of another computing board. For example, the host 110 may include a processor (e.g., one or more processors) and a memory (e.g., one or more memories), wherein the memory includes a non-transitory computer-readable storage medium storing code that, when executed by the processor, configure the processor to perform any one, any combination, or all of operations and/or methods disclosed herein with reference to FIGS. 1-40. The computing board 120 and host 110 may be part of a distributed computing system that may include other hosts and nodes.

The computing board 120 may include the computing devices 123 and switches 121. Additionally, the computing board 120 may further include connectors (not shown) that allow the switches 121 to be connected to switches on other computing boards or to each other. For ease of description, the computing board 120 may also be referred to as a “board”.

The electronic device 100 may be a computing device that connects the plurality of computing devices 123 through a multi-stage electrical interconnection network. As used herein, “electrical connection” or the like may refer to a network that transmits information in the form of electric current flowing through conductive lines/channels. For example, the electronic device 100 may include various computing devices such as a high-performance computer (HPC), a desktop, a workstation, and/or a server. An electrical interconnection network, for example, may be constructed with electrical wiring on a printed circuit board (PCB), and may be constructed cheaper and simpler than an optical interconnection network, which may have additional power consumption due to electrical-to-optical signal conversion and high costs due to transmission channels that provide optical paths, such as optical cables. A network of the electronic device 100 may be implemented by connecting the switches 121 and the plurality of computing devices 123, and connecting the switches 121 and the switches of other computing boards through connectors (e.g., corresponding to conductive lines, channels, cables, and/or wires). Through the network of the electronic device 100, the computing devices 123 within the computing board 120 may be connected to each other or to computing devices of other computing boards to transmit and receive data.

The switches 121 may connect the plurality of computing devices 123. The switches 121 may efficiently maintain bandwidth performance between the computing devices 123 by partitioning and transmitting data through a plurality of switches connected to an electrical connection network when transmitting data from one of the plurality of computing devices 123 to another.

When each of the switches 121 has a direct connection with any other one of the switches 121 without an intermediate switch, the switches 121 may have a horizontal structure. Additionally, each of the switches 121 may have a direct connection with any one of the switches within another computing board without an intermediate switch. A direct connection may indicate that a switch is electrically connected to another switch through a connector without going through other components (e.g., an intermediate switch).

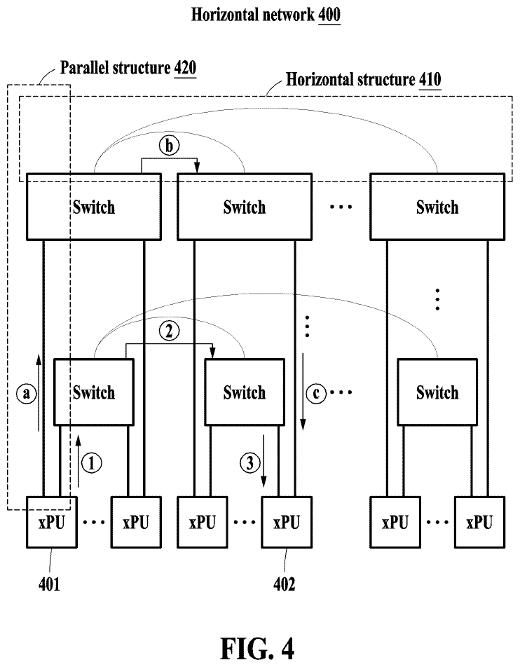

Additionally, the switches 121 may be connected in parallel to each other, thereby expanding the bandwidth of the network and controlling the number of links of the computing board. For ease of description, a structure in which switches included in a computing board are not connected to each other but are connected in parallel may be referred to as a parallel switch. Examples of the horizontal structure and parallel structure of the switches 121 are described in detail with reference to FIGS. 4 to 11 below.

For ease of description, FIG. 1 illustrates an example in which the electronic device 100 includes one computing board 120, but is not limited thereto, and the electronic device 100 may include a plurality of computing boards. A plurality of computing boards may be connected to each other with connectors and cables that connect to the switches 121. For example, a plurality of computing boards included in the electronic device 100 may be connected via an optical access network.

Additionally, although not shown in FIG. 1, the electronic device 100 may further include disaggregated resources or distributed resources such as storage, non-volatile memory or the like, an optical network, additional systems for management, and a network, depending on the examples.

The electronic device 100 of one or more embodiments may effectively maintain high bandwidth performance without using an optical access network that requires expensive optical cables by extending a range of the computing board 120 through an expanded electrical access network in which a plurality of switches are connected in a fabric form.

Referring to FIG. 2, a network 200 may be implemented by a plurality of computing boards 210 and 220.

A plurality of computing devices and a plurality of switches implementing the network 200 may be grouped into a plurality of groups. Computing devices and switches grouped in the same group may be arranged on a single computing board. For example, the number of computing devices included in each of the plurality of groups may be the same. Additionally, the number of switches included in each of the plurality of groups may be the same. In some examples, a group may function as a computing cluster to provide storage services, high-performance computing, distributed computing, and the like.

A computing device may include a memory (e.g., one or more memories) and/or a processor (e.g., one or more processors). The memory may be a device that stores data, and may be, for example, high-bandwidth memory. The processor may be a device that performs operations, and may include, for example, an xPU such as a central processing unit (CPU), a graphics processing unit (GPU), a neural processing unit (NPU), or a tensor processing unit (TPU), and/or a device such as a field programmable gate array (FPGA). In one or more examples, the computing device may be a computing endpoint running an operating system, and may be, for example, a component of a distributed application.

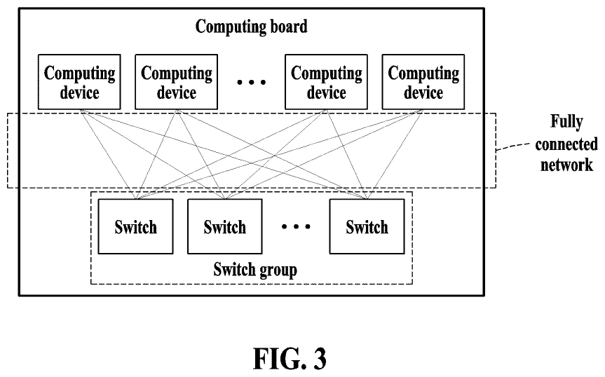

Connections between computing devices and switches within the same computing board and between switches on different computing boards may be based on an electrical interconnection network (e.g., based on switched serial electrical connections). For example, when data is transmitted from a first computing device 211 included in the first computing board 210 to a second computing device 221 included in the second computing board 220, the data partitioned from the first computing device 211 may be transmitted to the second computing device 221 through a switch fabric 230. For example, the first computing device 211 may partition and transmit the data to switches included in the first computing board 210, and the switches may transmit the partitioned data to switches included in the second computing board 220. Additionally, the switches included in the second computing board 220 may transmit the partitioned data to the second computing device 221, thereby ensuring that data transmission is not limited by the bandwidth of the electrical connection network. As will be described in detail in an example with reference to FIG. 3, the first computing device 211 may be connected to all switches included in the first computing board 210, and all second switches included in the second computing board 220 may be connected to the second computing device 221.

Through the structure of the switch fabric 230 of one or more embodiments, input/output (I/O) bandwidth performance between all computing devices within the computing board 200 may be effectively maintained. An example of the structure of the switch fabric 230 is described in detail with reference to FIG. 3.

FIG. 3 illustrates an example of connections within a computing board.

Referring to FIG. 3, computing devices and switches within a computing board may be fully interconnected as devices grouped into the same group. Each of the computing devices may be electrically connected to all switches within the same group. For example, each of the computing devices may be connected to the switches with the same bandwidth, but the example is not limited thereto. Additionally, each of the switches may be connected to all computing devices within the same group. Similarly, each of the switches may be connected to the computing devices with the same bandwidth, but the example is not limited thereto.

Within the same group, the computing devices may not be directly connected to each other, and the switches may not be directly connected to each other. That is, within the same group, a computing device may not be directly connected to another computing device, and a switch may not be directly connected to another switch.

As illustrated in FIG. 3, a plurality of switches within a computing board may be referred to as a switch group.

FIG. 4 illustrates an example of a structure of switches.

Referring to FIG. 4, a horizontal network 400 may be implemented by switches connected in a horizontal structure 410 and a parallel structure 420 within an electronic device.

The horizontal structure 410 may be a structure in which switches are connected horizontally rather than hierarchically. For example, each of the switches implemented in the horizontal structure 410 may be directly connected to each other through connectors without going through an intermediate switch. The switches may provide a uniform connection between computing devices through the horizontal structure 410. Additionally, the horizontal structure may expand the connection structure between the switches.

The parallel structure 420 may be a structure in which the switches are not directly connected to each other and are connected in parallel to the computing devices. For example, each of the switches may be directly connected to at least a portion of the computing devices. The switches may increase the utilization of end switches and expand the network bandwidth of the electronic device through the parallel structure 420.

The electronic device of one or more embodiments may reduce a path connecting any one of the computing devices to another computing device through the horizontal structure 410 and the parallel structure 420 compared to a hierarchical structure, and may adjust the number of links according to a required bandwidth with an exclusive connection. Computing devices within a computing board may be connected uniformly through switches. Additionally, a plurality of computing boards may be uniformly connected via connecting cables.

In an example of FIG. 4, through the horizontal structure 410 and the parallel structure 420, any one of the computing devices may be connected to another computing device through only one of the switches. For example, a computing device 401 among the computing devices may be connected to another computing device 402 through only one switch, either through paths connected to \textcircled{1}, \textcircled{2}, and \textcircled{3}, or through paths connected to \textcircled{a}, \textcircled{b}, and \textcircled{c}.

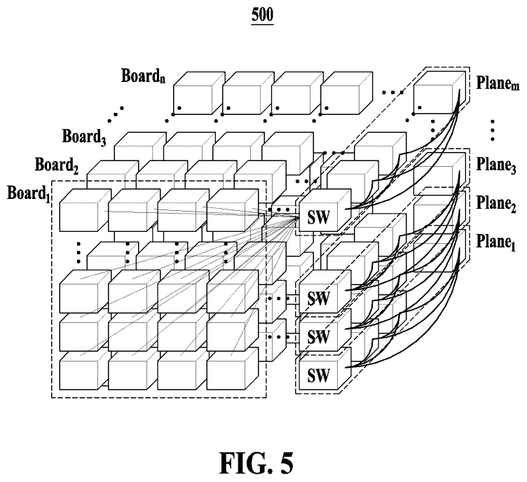

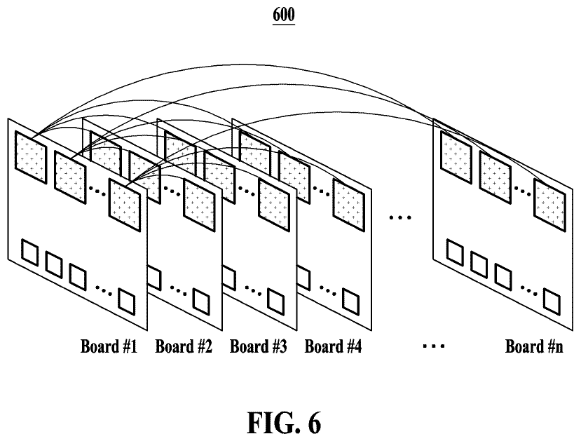

FIGS. 5 and 6 illustrate examples of connections of computing devices.

Referring to FIG. 5, an example of a connection structure in which computing devices within a computing board are connected to switches in a horizontal network 500 is illustrated.

In an example, the horizontal network 500 may provide a uniform connection between the computing devices. The horizontal network 500 of one or more embodiments may reduce a reachable path from a computing device to another computing device by providing a uniform connection between the computing devices. Additionally, the horizontal network 500 may be structured such that the number of links may be adjusted through a parallel structure of switches that are exclusively connected. For ease of description, the computing devices may also be referred to as “nodes,” “computation nodes,” or “computing nodes.”

In FIG. 5, the horizontal network 500 is illustrated as a structure in which the computing devices are connected to one switch within one computing board, but this is for illustrative purposes only and the examples are not limited thereto. The computing devices may be connected to a plurality of switches and to other computing boards in the same structure.

In addition, connectors connecting the switches in the horizontal network 500 are omitted for brevity, but according to examples, switches included in the same plane may be connected through connectors. A plane may be a structure that connects switches mounted on different computing boards. For example, switches positioned on the same plane may be connected in a parallel switch structure. The switches positioned on the same plane may generate parallel channels between a plurality of computing boards. For example, a parallel channel may have a maximum number of channels that may be split across switches on the same plane.

Referring to FIG. 6, an example of a physical arrangement structure of a horizontal network 600 implementing the connection structure of FIG. 5 is illustrated.

In FIG. 6, the switches of all computing boards may be connected horizontally, such that the computing devices of all computing boards may be uniformly connected to each other. In FIG. 6, the connections between the switches and computing devices within each computing board are omitted for brevity.

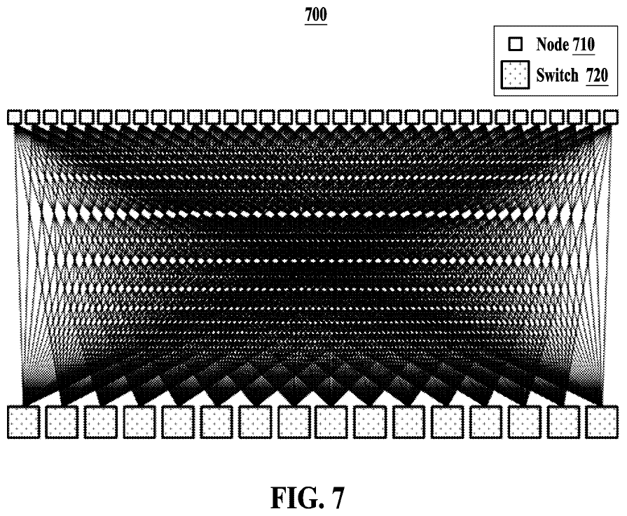

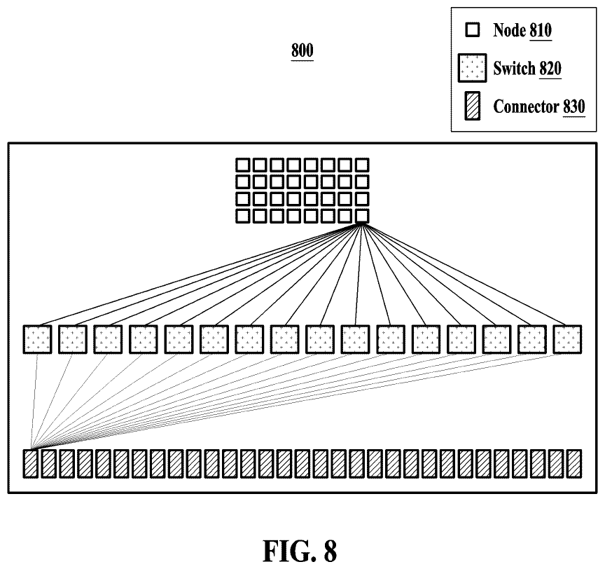

FIGS. 7 and 8 illustrate examples of connections between computing devices, switches, and connectors within a computing board.

Referring to FIG. 7, an example of a connection structure in which computing devices within the same computing board are uniformly connected through switches 720 in a horizontal network 700 is illustrated.

In an example, the horizontal network 700 may be configured such that all nodes 710 representing the computing devices within a computing board are uniformly connected through the switches 720 within the computing board. Additionally, in the horizontal network 700, the number of links between the nodes 710 within a computing board may be adjusted via parallel switches to suit the required bandwidth to communicate with other nodes.

As used herein, the number of nodes 710 within a computing board may be expressed as N_{node}, the number of switches 720 within a computing board may be expressed as N_{sw}, and the number of connectors within a computing board may be expressed as N_{conn}.

Referring to FIG. 8, an example of a physical arrangement structure of a horizontal network 800 implementing the connection structure of FIG. 7 is illustrated.

A node 810 may be connected to switches 820, and the switches 820 may be connected to a connector 830. Additionally, each node within a computing board may be connected to a plurality of switches, and each connector may be connected to a plurality of switches, such that all nodes within the computing board may be connected uniformly. In FIG. 8, for brevity, only the connection of switches to one node and one connector is shown, and the connection of switches to the remaining nodes and remaining connectors is omitted.

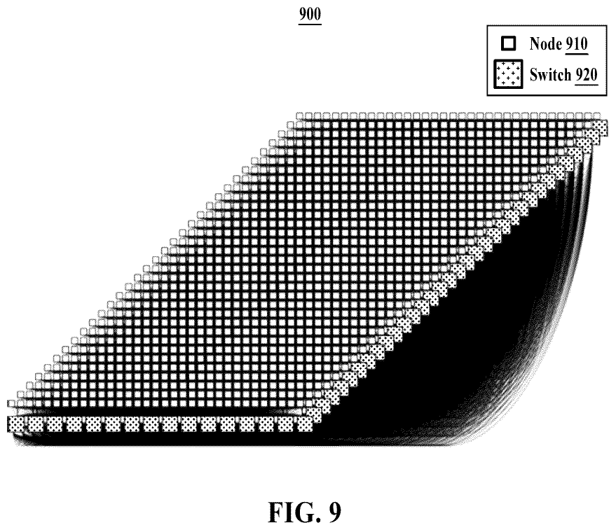

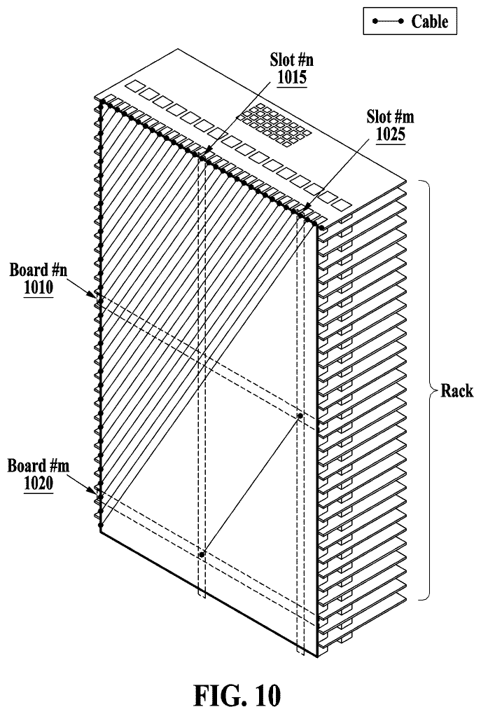

FIGS. 9 and 10 illustrate examples of connections of computing boards.

Referring to FIG. 9, an example of a connection structure in which computing boards within a rack are uniformly connected via connectors and cables in a horizontal network 900 is illustrated.

In an example, the horizontal network 900 may uniformly connect all computing boards within a rack. Additionally, when the computing boards are uniformly connected in the horizontal network 900, the number of links may be adjusted through parallel switches to suit the required bandwidth to communicate between nodes within different computing boards.

When all computing boards are connected uniformly, any one node 910 within the computing board may be uniformly connected to nodes of other computing boards through connected switches 920, connectors, and cables.

Referring to FIG. 10, an example of a physical arrangement structure of a horizontal network implementing the connection structure of FIG. 9 is illustrated.

Each computing board within a rack may be connected to each other computing board via cables. The computing boards may be connected to each other by connecting cables to cable slots (e.g., of connectors) corresponding to each computing board. For example, an n-th computing board 1010 and an m-th computing board 1020 may be connected by connecting a cable to an m-th cable slot 1025 of the n-th computing board 1010 and an n-th cable slot 1015 of the m-th computing board 1020. However, the connection structure between the computing boards illustrated in FIG. 10 is provided only as an example, and embodiments are not limited thereto. The computing boards may be connected using various structures and schemes.

As used herein, the number of cables in a rack may be expressed as Nₗᵢₙₖ, the number of computing boards in a rack may be expressed as Nord, and the number of wires in a rack may be expressed as N_{dp}, where dp denotes a differential pair.

The number of cables for a horizontal network to provide a uniform connection between all nodes may be determined by the number of switches, the number of connectors, and the number of wires. As in the example of FIG. 10, when all wires of the connector are connected with a single cable, the number of cables of the horizontal network may be determined as expressed by Equation 1 below, for example.

$${N}_{link} \leq ( \begin{matrix}{N}_{conn} \\ 2\end{matrix} ) = {N}_{conn} \times ( {N}_{conn} - 1 ) / 2 such that {N}_{brd} \leq {N}_{conn} \qquad Equation 1$$

As used herein, the total number of wires connecting a connector within a computing board to another computing board may be expressed as N_{dp, max}.

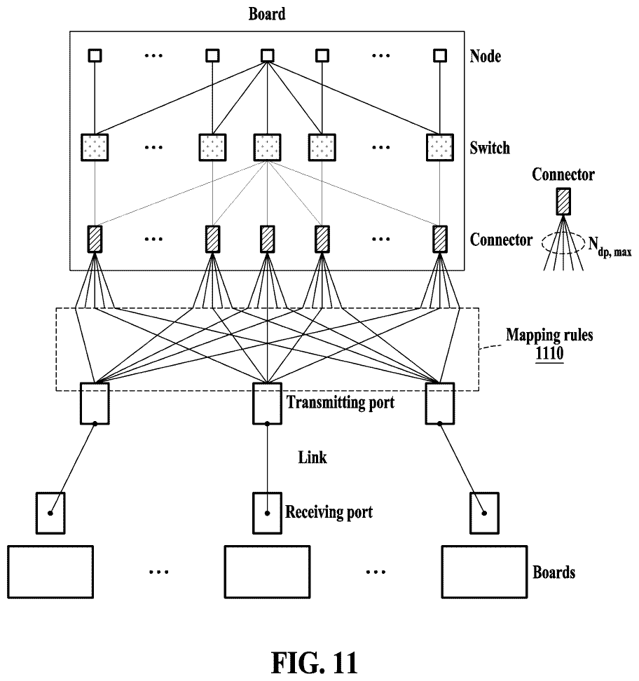

However, in an example, the number of cables to connect all computing boards may be adjusted according to mapping rules, depending on the number of wires and the number of connectors. Examples of a structure and method to implement a horizontal network according to the mapping rules are described in detail with reference to FIGS. 11 to 15 below.

FIG. 11 illustrates an example of a structure of an electronic device.

Referring to FIG. 11, connectors within a computing board may be connected to other computing boards according to mapping rules 1110.

In an example, a horizontal network of an electronic device may have one or more of the following structures.
Horizontal structure: There may be direct links between computing boards to uniformly connect switches.
Parallel structure: The number of links between the computing boards may be adjusted as the switches are connected in parallel rather than directly to each other.
Partitioned connection structure: An operating distance between computing devices may be reduced by connecting one or more connectors and a switch.

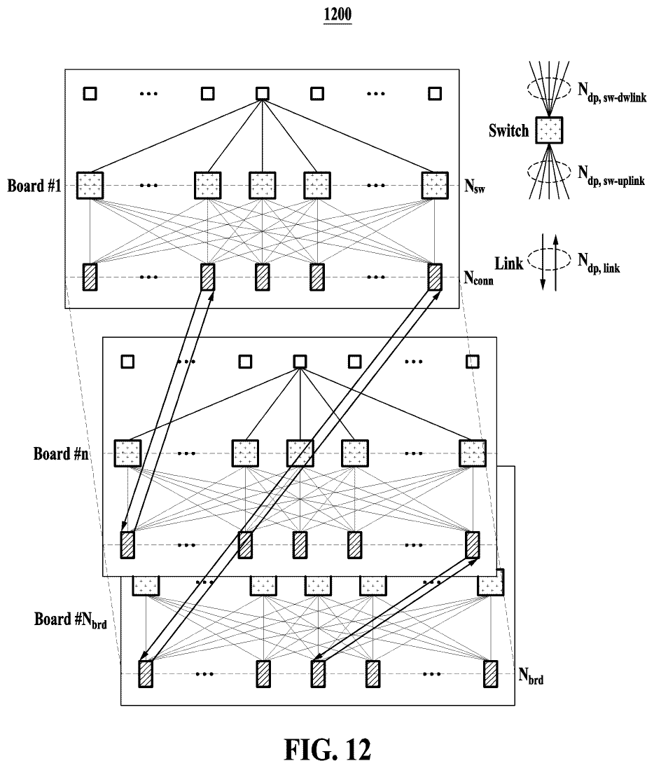

FIG. 12 illustrates an example of connections of computing boards.

Referring to FIG. 12, an example of a connection structure between connectors in a network 1200 of a horizontal structure and a parallel structure is illustrated.

When connecting from one of the computing boards to another of the computing boards in a rack, and when the total number of wires of the connectors in the computing board is sufficiently large, the electronic device of one or more embodiments may prevent network congestion with respect to the switches on the board when Equation 2 below, for example, is satisfied.

$${N}_{conn} \times {N}_{dp , max} \geq {N}_{s w} \times {N}_{dp , sw - uplink} \qquad Equation 2$$

Here, N_{conn} denotes the number of connectors, N_{dp, max} denotes the total number of wires in a connector, N_{sw} denotes the number of switches, and N_{dp, sw-uplink} denotes the number of wires connecting a switch to the connectors. Additionally, N_{dp, sw-dwlink} denotes the number of wires connecting a switch to computing devices, and N_{dp, link} denotes the number of links to which connectors are connected.

The number of connectors, the number of wires per cable, and the total number of cables to implement the horizontal structure of the network 1200 may be expressed by Equations 3, 4, and 5 below, for example.

$${N}_{conn} \geq {N}_{brd} \qquad Equation 3$$

$${N}_{dp , link} = {N}_{dp , max} \qquad Equation 4$$

$${N}_{link} = {N}_{brd} \times ( {N}_{brd} - 1 ) / 2 \qquad Equation 5$$

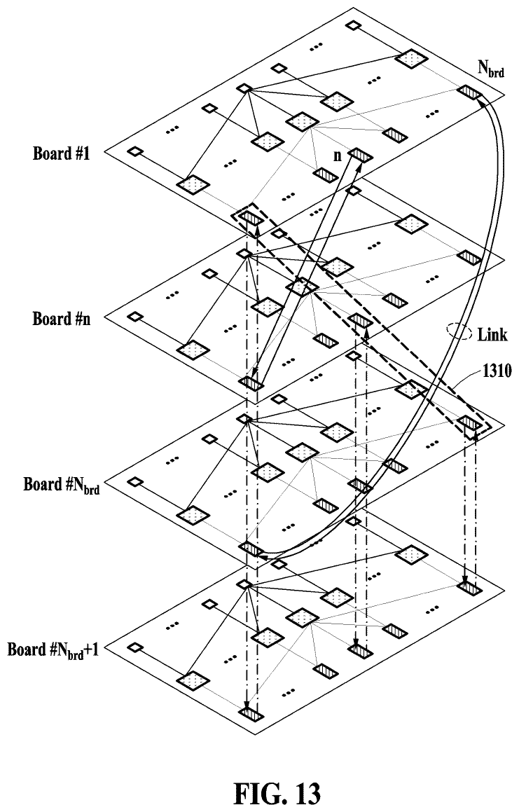

Referring to Equation 3, the number of connectors N_{conn} to implement the horizontal structure may be greater than or equal to Nord. Equation 3 may be derived from a method of connecting the m-th cable slot of the n-th computing board to the n-th cable slot of the m-th computing board when connecting from the n-th computing board to another m-th computing board in the cable connection between computing boards of the example of FIG. 10 for easy explanation of a horizontal structure. An example of equation 3 will be described further with reference to FIG. 13.

In addition, the number of connectors, the number of wires per cable, and the total number of cables to implement the horizontal structure of the network 1200 may be determined as expressed by Equations 6 to 8 below, for example, from Equations 3 to 5.

$$\begin{matrix}{N}_{conn} \times {N}_{dp , max} \geq {N}_{s w} \times {N}_{dp , sw - uplink} \\ {N}_{conn} \times {N}_{dp , max} \geq ( {N}_{brd} - 1 ) \times {N}_{dp , link}\end{matrix} \qquad Equation 6$$

$${N}_{conn} \geq max [ ( {N}_{brd} - 1 ) \times {N}_{dp , link} / {N}_{dp , max} , {N}_{s w} \times {N}_{dp , sw - uplink} / {N}_{dp , max} ] \qquad Equation 7$$

$${N}_{brd} \times ( {N}_{brd} - 1 ) / 2 \leq {N}_{link} \qquad Equation 8$$

FIG. 13 illustrates an example of a connection of computing boards according to a horizontal structure of an electronic device. Referring to FIG. 13, the computing boards may be connected to each other through cable slots corresponding to each computing board. The connection structure between the computing boards illustrated in FIG. 13 is provided only as an example, and embodiments are not limited thereto.

There may be no recursive connection from an n-th computing board to an n-th cable slot to connect to the n-th computing board. For example, in FIG. 13, connectors that are to be connected to themselves may not be utilized for cable connections. In this example, connector slots 1310 to connect to oneself may not be utilized. As used herein, the connector slots 1310 may also be referred to as diagonal connector slots for ease of description.

In an example, the connector slots 1310 may be used to add the number of computing boards within a rack. Additionally, since the connector slots 1310 have the characteristic of being directly connected to all computing boards within the rack, the connector slots 1310 may be utilized to add a redundant board that considers system reliability availability serviceability (RAS) characteristics, or to add a board for a fabric manager that performs computing board management functions within the rack. As shown in the example of FIG. 13, when a system scale of an electronic device is expanded, equation N_{brd}+1=N_{conn} may be established. For example, a rack may include N_{brd}+1 computing boards, with Nord computing boards capable of being connected between computing nodes, and an additional computing board utilized for other purposes.

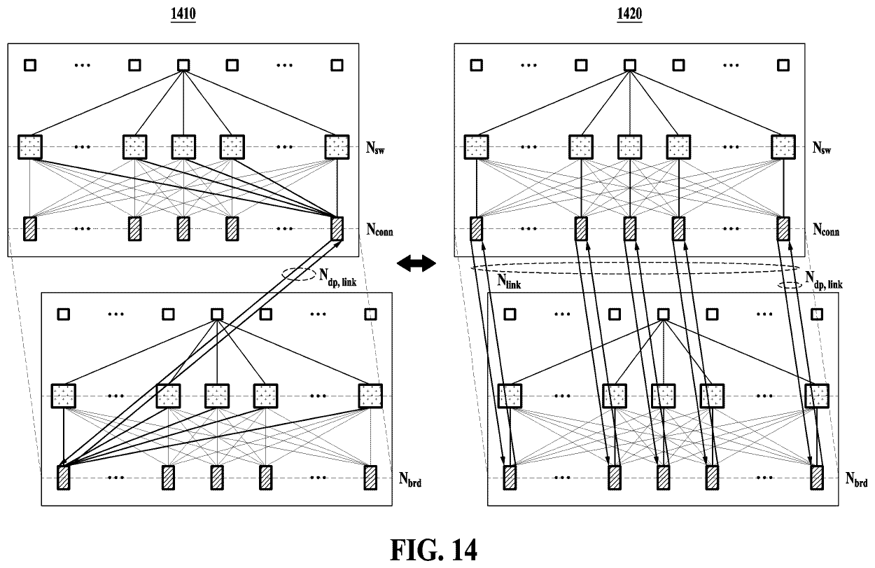

FIG. 14 illustrates an example of a partitioned connection structure of an electronic device.

Referring to FIG. 14, examples of a network in which connectors are connected in a bundled connection structure 1410 and a network in which connectors are connected in a partitioned connection structure 1420 are illustrated.

In an example, connectors within a computing board may be connected to connectors of another computing board in the bundled connection structure 1410 or the partitioned connection structure 1420. Additionally, according to examples, the connectors may be connected in the bundled connection structure 1410 or the partitioned connection structure 1420 depending on the connector.

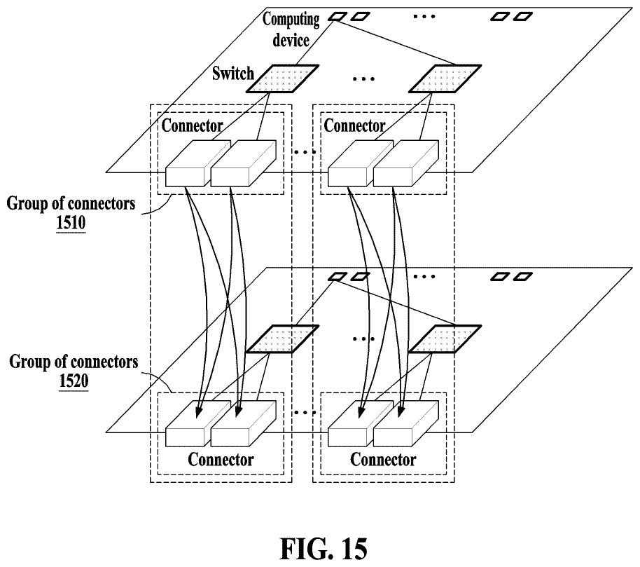

Connectors within a predetermined computing board may be connected to connectors within another computing board to which they are mapped. The connectors may be grouped into a plurality of groups. When the connectors are grouped into a plurality of groups, a group of connectors within a computing board may be mapped to a group of connectors within another computing board. For example, the group of connectors within a computing board may map one-to-one with the group of connectors within another computing board. The group of connectors may be connected to transmit and receive data with the group of connectors within another computing board to which it is mapped. When the group of connectors is grouped, cables connected to the group of connectors may also be grouped. For ease of description, the grouping of cables may also be referred to as bundling. An example of the grouping of connectors is described in detail with reference to FIG. 15 below.

The bundled connection structure 1410 may be a structure in which a computing device within a predetermined computing board is connected to a computing device within another computing board through a connection of a group of connectors that is connected one-to-one with a group of connectors. For example, one group of connectors may be used per computing board to connect a computing device within a predetermined computing board to a computing device within another computing board. Referring to Equation 5 described above, when the connectors are connected in the bundled connection structure 1410, the electronic device of one or more embodiments may reduce the total number of cables to connect the computing boards. Additionally, since the connectors are connected in the bundled connection structure 1410, the size and complexity of an overall system including a plurality of computing boards may be reduced.

The partitioned connection structure 1420 may be a structure in which a computing device within a predetermined computing board is connected to a computing device within another computing board through a connection of two or more groups of connectors that are connected one-to-one with each of two or more groups of connectors. For example, two or more groups of connectors may be used per computing board to connect a computing device within a predetermined computing board to a computing device within another computing board. A path connecting the computing devices through the partitioned connection structure 1420 may be split into a plurality of paths. When the connectors are connected through the partitioned connection structure 1420, the electronic device of one or more embodiments may reduce an asymmetry in a connection distance between an end switch and a connector within the computing board, may reduce an operating distance for connection between the switches and connectors within a computing board, and may reduce the connection distance and/or operating distance between the computing devices and reduce a path loss.

In the partitioned connection structure 1420, the total number of cables to connect the computing boards may be determined through Equation 9 below, for example.

$${N}_{link} = {N}_{part} \times {N}_{b r d} \times ( {N}_{brd} - 1 ) / 2 \qquad Equation 9$$

Here, Nₚₐᵣₜ denotes a partition multiplier or a partition ratio, which may represent a factor for an increase in the number of cables when connected in the partition connection structure 1420 compared to the bundle connection structure 1410. Using the partitioned connection structure 1420, the electronic device of one or more embodiments may reduce a path loss by connecting the connectors within a computing board to predetermined end switches without having to connect them to all end switches, and may allow a computing board to be connected to more computing boards by allocating extra paths to the connections between computing boards.

FIG. 15 illustrates an example of a group of connectors.

Referring to FIG. 15, an example of a group of connectors 1510 in which a plurality of connectors within a computing board are grouped and a group of connectors 1520 within another computing board that is mapped to the group of connectors 1510 is illustrated. In FIG. 15, the group of connectors 1510 and 1520 are illustrated as including two connectors, but embodiments are not limited thereto, and the number of connectors included in the group of connectors 1510 and 1520 may be one or more.

In an example, an electronic device may include switches connected to one or more connectors. Additionally, the electronic device may include the group of connectors 1510 including one or more connectors. The groups of connectors connected in parallel with the switches may be exclusively connected to other groups of connectors. For example, the group of connectors 1510 may be connected one-to-one with the group of connectors 1520 in another computing board to which it is mapped.

First connectors included in the group of connectors 1510 on a reference computing board may be connected to second connectors of the group of connectors 1520 on another computing board that is mapped to the group of connectors 1510. As in the example of FIG. 11, the first connectors may be respectively connected to the second connectors. However, the structure in which the group of connectors 1510 and 1520 are mapped and the structure in which the connectors included in the group of connectors 1510 and 1520 are connected may differ according to examples.

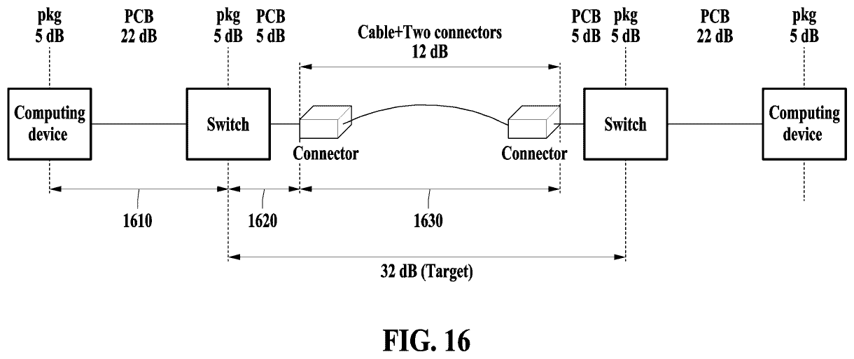

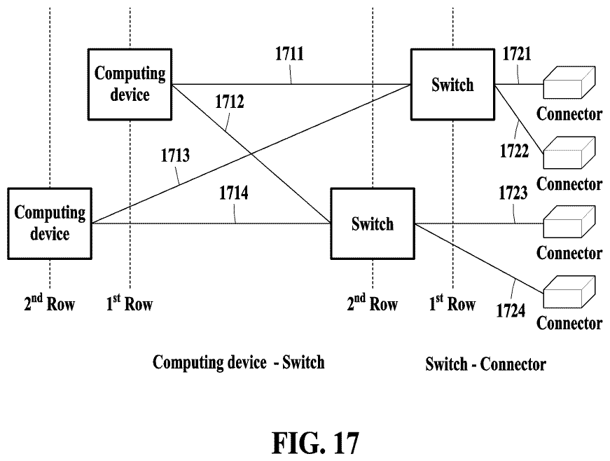

FIGS. 16 and 17 illustrate examples of a path loss of a connection structure.

Referring to FIG. 16, an example of a computing device-switch connection 1610, a switch-connector connection 1620, and a connector-connector connection 1630 is illustrated. A path loss may occur in each connection 1610, 1620, and 1630 depending on a path length for data transmission. Each connection 1610, 1620, and 1630 may be configured such that the path loss is less than or equal to a threshold based on a link budget. Additionally, losses (e.g., 5 dB) to data transmission may occur in components (e.g., computing devices, switches) of an electronic device.

For example, each component and connection may be arranged such that the computing device-switch connection 1610 has a path loss less than or equal to 22 dB, the switch-connector connection 1620 has a path loss less than or equal to 5 dB, and the connector-connector connection 1630 has a path loss less than or equal to 12 dB, based on a predetermined link budget. In this example, the switch and connector may be arranged such that the loss for a switch-connector-cable-connector-switch connection is less than or equal to 32 dB.

Referring to FIG. 17, an example of computing device-switch connections 1711, 1712, 1713, and 1714 and switch-connector connections 1721, 1722, 1723, and 1724 in a partitioned connection structure is illustrated. The partitioned connection structure of one or more embodiments may reduce an operating distance by connecting switches to a predetermined group of connectors such that a path loss is less than or equal to a threshold level.

The switch-connector connections 1721, 1722, 1723, and 1724 may be arranged with a limited operating distance to reduce maximum/minimum path loss by considering a path-wise loss model, rather than randomly connecting from switches to connectors similar to the computing device-switch connections 1711, 1712, 1713, and 1714. The path-wise loss model may be determined, for example, as shown in Table 1 below, for example.

TABLE 1

| PCB Trace Loss Model | | Compute - Switch | | | Switch - Connector | | |
|---|---|---|---|---|---|---|---|
| (85 ohm diff impedance) | | <100 mm | <200 mm | <650 mm | <50 mm | <100 mm | <150 mm |
| HDI 1 | 0.028 dB/mm | 3.3 dB | 6.6 dB | | 1.7 dB | 3.3 dB | |
| HDI 2 | 0.031 dB/mm | 3.0 dB | 6.0 dB | | 1.5 dB | 3.0 dB | |
| MLB 1 | 0.021 dB/mm | | | 14.6 dB | | | 3.4 dB |

| | |
|---|---|
| Link Budget 22 dB (Margin: 7.4 dB) | Link Budget 5 dB (Margin: 1.6 dB) |

The path-wise loss model may include information on a path loss per wire length. Wires connecting the switches and computing devices and/or wires connecting the switches and connectors may be determined as high-density interconnect (HDI) traces or multi-layer board (MLB) traces depending on the path loss per wire length. Additionally, the specifications, path, or structure of HDI traces and/or MLB traces may be determined differently depending on the path loss per wire length.

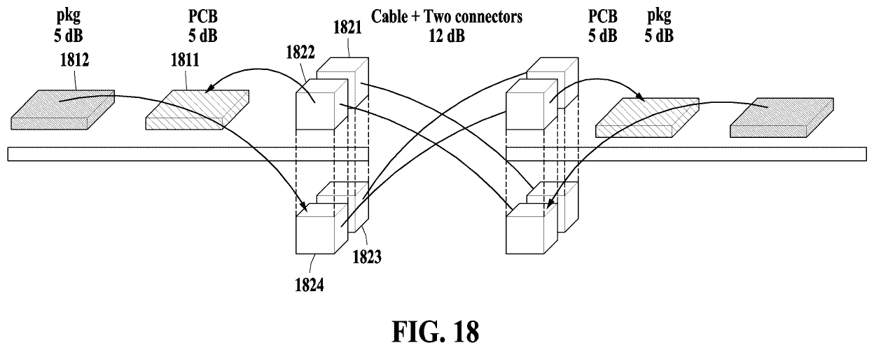

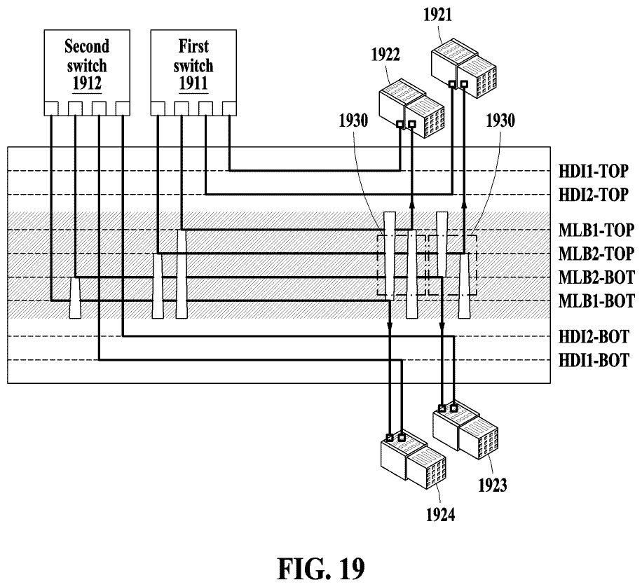

FIGS. 18 and 19 illustrate examples of an arrangement of switches and connectors.

Referring to FIG. 18, one or more of the connectors 1821, 1822, 1823, and 1824 may be arranged on a first surface of a computing board, and the remaining connectors may be arranged on a second surface of the computing board. In the example of FIG. 18, the connectors 1821 and 1822 may be arranged on the first surface of the computing board, and the connectors 1823 and 1824 may be arranged on the second surface of the computing board. The first surface and the second surface of the computing board may be opposite surfaces on the computing board. For example, the first surface may be the top surface of the computing board, the second surface may be the bottom surface of the computing board, and the connectors 1821, 1822, 1823, and 1824 may be arranged vertically with respect to the computing board.

Additionally, among switches 1811 and 1812, the first switch 1811 may be arranged closer to the connectors on the computing board than the remaining second switch 1812. For example, the first switch 1811 and the second switch 1812 may be arranged in a first column and a second column on the computing board, respectively. The first column may be arranged close to the connectors 1821, 1822, 1823, and 1824 and the second column may be arranged far from the connectors 1821, 1822, 1823, and 1824.

Through arrangements according to an example, the switches 1811 and 1812 and the connectors 1821, 1822, 1823, and 1824 may be arranged three-dimensionally in a limited space. Additionally, the switches 1811 and 1812 and the connectors 1821, 1822, 1823, and 1824 may be arranged within a limited path loss threshold (e.g., 5 dB, 12 dB).

Referring to FIG. 19, an example of connectors 1921 and 1922 arranged on a first surface of a computing board and connectors 1923 and 1924 arranged on a second surface of the computing board, and a first switch 1911 arranged on a first column of the computing board and a second switch 1912 arranged on a second column of the computing board, in a multi-layer wiring structure, is illustrated. The connectors 1921 and 1922 arranged on the first surface of the computing board may be respectively connected to the switches 1911 and 1912 such that no crosstalk occurs with the connectors 1923 and 1924 arranged on the second surface of the computing board, as shown in area 1930.

A multi-layer wiring structure may include MLB layers and HDI layers. Since MLB layers may have a simpler via structure than HDI layers, an interstitial via hole (IVH) in the form of a through-hole via through a mechanical drill may be used for MLB layer stacking, and back-drilling may be applied to remove unnecessary parts during multi-layer signal wiring. In the case of HDI layers, a micro via hole (MVH) through a laser drill may be used for HDI layer stacking such that only the necessary parts may be connected during multi-layer wiring, allowing connections to be made freely.

HDI traces may be easier to form than MLB traces, but when the wiring thickness is constructed to be thin, a loss per wiring length may increase making it advantageous for short-distance, high-density wiring, while MLB traces may be advantageous for long-distance, low-density wiring. On a computing board, computing devices, switches, and connectors may be interconnected with HDI traces or MLB traces, depending on a wiring length and/or wiring density.

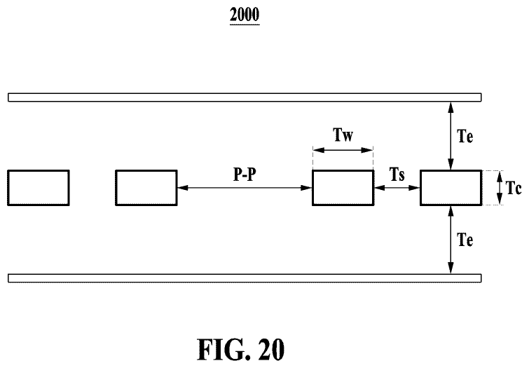

FIG. 20 illustrates an example of a multi-layer wiring.

Referring to FIG. 20, an example of a stripline model 2000 for a multi-layer wiring is illustrated. For example, the stripline model 2000 may be a model implementing a wiring structure inside a computing board.

For example, a multi-layer wiring may be implemented according to the following specifications of the stripline model 2000.

$$HDI Trace : Tw = 3.7 mil ( 100 um ) , Ts = 3.6 mil ( 100 um ) , P - P = 12 mil ( 300 um ) , Tc = 3 / 8 oz , Te = 3 mil ( 75 um )$$

$$MLB trace : Tw = 5.85 mil ( 150 um ) / Ts = 4.15 mil ( 100 um ) / PP = 25 mil ( 635 um ) , Tc = 1 oz , Te = 5 mil ( 125 um )$$

However, the above-described specifications are provided only as an example, and embodiments are not limited thereto. The specifications of the stripline model 2000 may be determined differently according to embodiments.

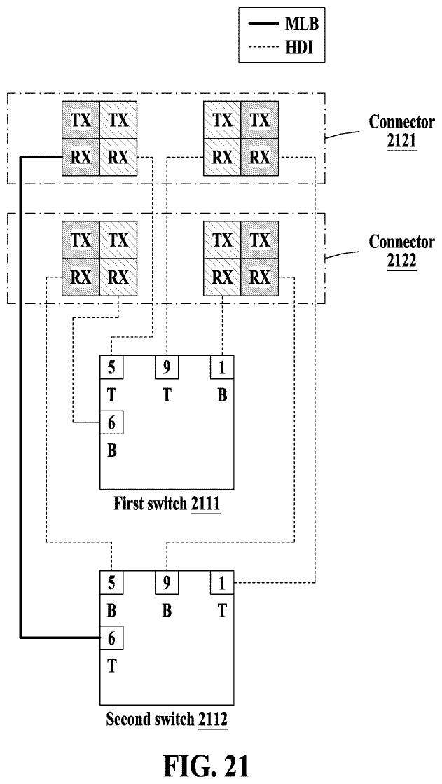

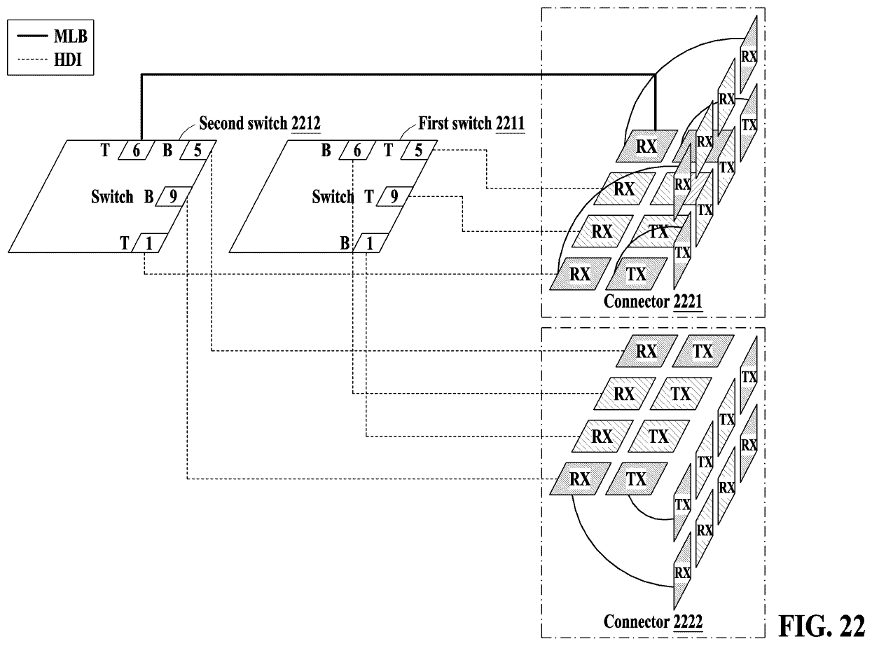

FIGS. 21 and 22 illustrate examples of connections of MLB traces and HDI traces.

Referring to FIG. 21, an example of a structure in which connectors 2121 arranged on a first surface and connectors 2122 arranged on a second surface are connected to a first switch 2111 and a second switch 2112 with MLB traces (shown in solid lines) or HDI traces (shown in dotted lines) depending on a wiring length is illustrated.

For example, one or more of the connections of the second switch 2112 may be connected as MLB traces such that a loss is less than or equal to a threshold when connected as HDI traces. In addition, considering the connector structure arranged on the first surface and the second surface, the switches 2111 and 2112 may be connected to the connectors 2121 and 2122 such that signals transmitted from the first switch 2111 and the second switch 2112 are received separately by a transmitter (TX) or a receiver (RX) of the connectors 2121 and 2122.

Additionally, the transmitter and the receiver of the connectors may be arranged according to a distance from the switches 2111 and 2112. For example, the receiver of a connector may be arranged close to the switches 2111 and 2112 and the transmitter of a connector may be arranged far from the switches 2111 and 2112 (e.g., further than the receiver of the connector). In this example, the receiver may be closer to the switches 2111 and 2112 than the transmitter, but a distance difference may not be large, and when wiring layers are allocated, the transmitter may be assigned to a deeper layer than the receiver, such that a deep via may be used.

Referring to FIG. 22, a side view of an arrangement structure of a first switch 2211, a second switch 2212, a connector 2221, and a connector 2222 is illustrated. The switches 2211 and 2212 and the connectors 2221 and 2222 may be arranged three-dimensionally on a computing board.

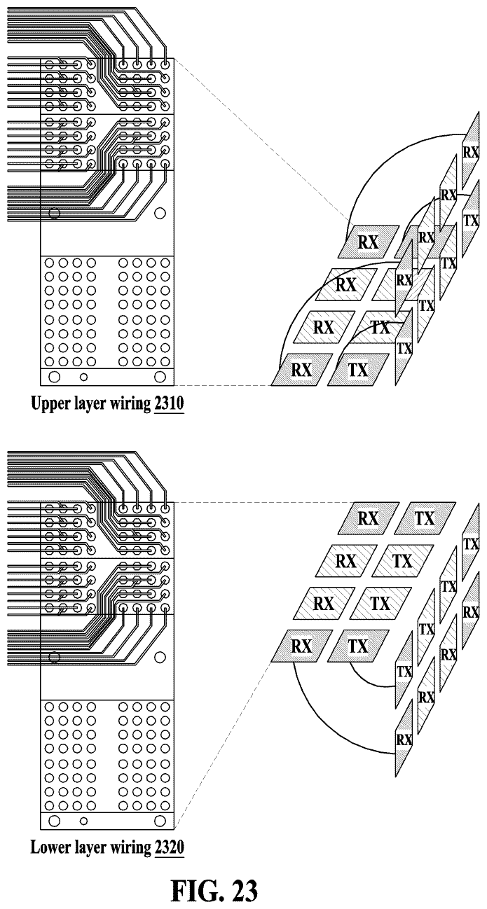

FIG. 23 illustrates an example of connections of a multi-layer wiring structure.

Referring to FIG. 23, an example of an upper layer wiring 2310 and a lower layer wiring 2320 arranged in a multi-layer wiring structure is illustrated. In FIG. 23, the upper layer wiring 2310 shows connectors arranged on a first surface of a computing board, and the lower layer wiring 2320 shows connectors arranged on a second surface of the computing board. However, the wiring structure illustrated in FIG. 23 is provided only as an example, and embodiments are not limited thereto.

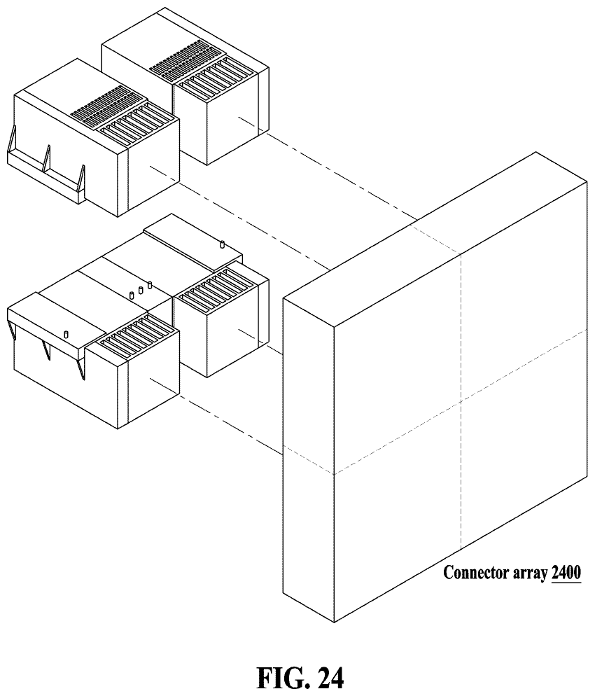

FIG. 24 illustrates an example of a connector array.

Referring to FIG. 24, a connector array 2400 may include a group of connectors. The connector array 2400 may be a structure in which connector arrays included in a group of connectors are arranged. Each cell of the connector array 2400 may represent a connector, and each cell may include a plurality of transmitters and receivers included in the connector. In FIG. 24, the connector array 2400 is illustrated as a structure in which four connectors are arranged in a 2×2 array, but embodiments are not limited thereto, and one or more connectors in the connector array 2400 may be arranged in various arrangements. For example, a connector array may have two connectors arranged in a 2×1 array.

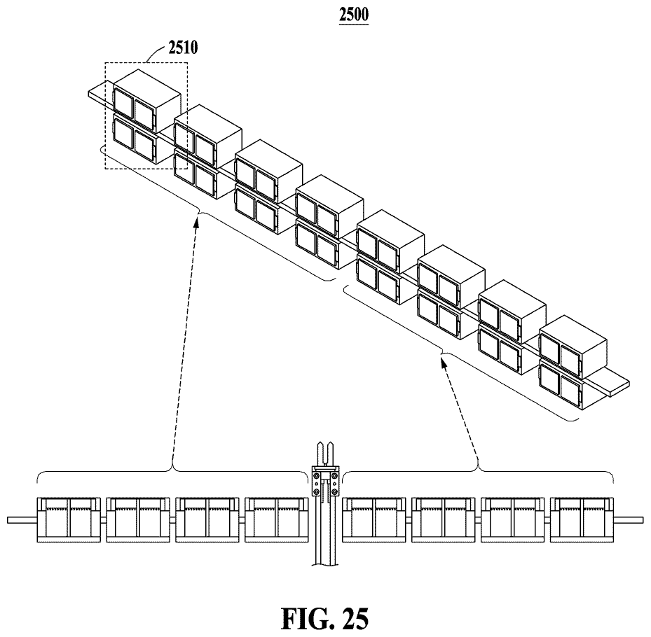

FIG. 25 illustrates an example of an arrangement structure of a connector array.

Referring to FIG. 25, connector arrays 2500 for a group of connectors may be arranged in a row. A connector array 2510 may be a group of connectors arranged in a 2×2 array. In the example of FIG. 25, 8 connector arrays may be arranged in parallel on a computing board.

A partitioned network structure may be implemented where switches are exclusively connected to predetermined connector arrays. In an example, the switches may be exclusively connected to n connectors, thereby implementing an n-partitioned network structure. In the example of FIG. 25, the switches may be connected to all 8 connector arrays, thereby implementing an 8-partitioned network structure. In another example, the switches may be connected to 4 of the 8 connector arrays, thereby implementing a 4-partitioned network structure. In another example, the switches may be connected to one of the 8 connector arrays, thereby implementing a network structure based on bundled connections. By configuring components in three dimensions and arranging the components in parallel on one side of a computing board, the electronic device of one or more embodiments may provide parallel networks and provide sufficient network bandwidth.

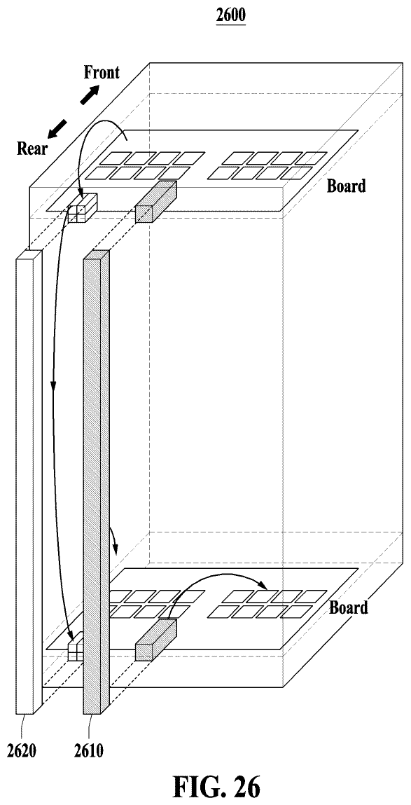

FIG. 26 illustrates an example of a structure of a rack.

Referring to FIG. 26, an example structure of a rack 2600 including a plurality of computing boards is illustrated. The rack 2600 may be powered through a busbar 2610. Additionally, a partitioned network may be provided by arranging cable slots 2620 on both sides of the rack 2600. For example, n cable slots may be arranged for n group of connectors, thereby implementing an n-partitioned network. For example, the rack 2600 may have 4 cable slots on each side for an 8-partitioned network.

The structure of a computing board may be determined based on the structure of the rack 2600. For example, a computing board may include busbar connectors to connect to busbars and connector arrays to connect to cable slots. In the example of FIG. 26, the computing board may include a busbar connector to connect to the busbar 2610 and eight 2×2 connector arrays to connect to 8 cable slots.

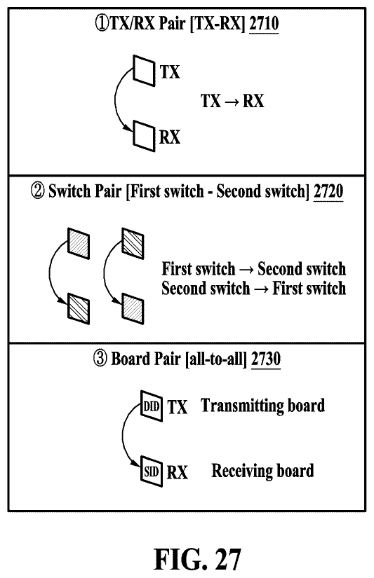

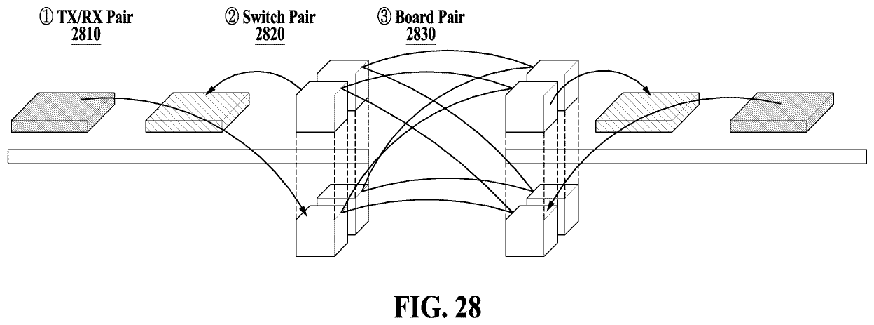

FIGS. 27 and 28 illustrate examples of pairs connected between computing boards.

Referring to FIG. 27, wires and cables may be connected to each other in predetermined pairs.

As used herein, a transmitter may be referred to as TX, a receiver may be referred to as RX, a destination address (destination ID) may be referred to as DID, and a source address (source ID) may be referred to as SID for ease of description.

In an example, the connectors, switches, and computing boards may be connected according to predetermined pairs 2710, 2720, and 2730. For example, each pair 2710, 2720, and 2730 may be as follows.

TX/RX Pair 2710: The transmitter of a connector within a computing board may be connected to the receiver of a connector within another computing board (TX-RX).

Switch Pair 2720: A first switch within a computing board may be connected to a second switch within another computing board. Additionally, the second switch within the computing board may be connected to the first switch (first switch-second switch).

Board Pair 2730: Each computing board may be connected to each other (all-to-all or any-to-any).

Referring to FIG. 28, an example of a structure in which connectors, switches, and computing boards are connected according to each pair 2810, 2820, and 2830 is illustrated. Hereinafter, for ease of description, the descriptions made with reference to the drawings are based on a 2×2 connector array, but embodiments are not limited thereto.

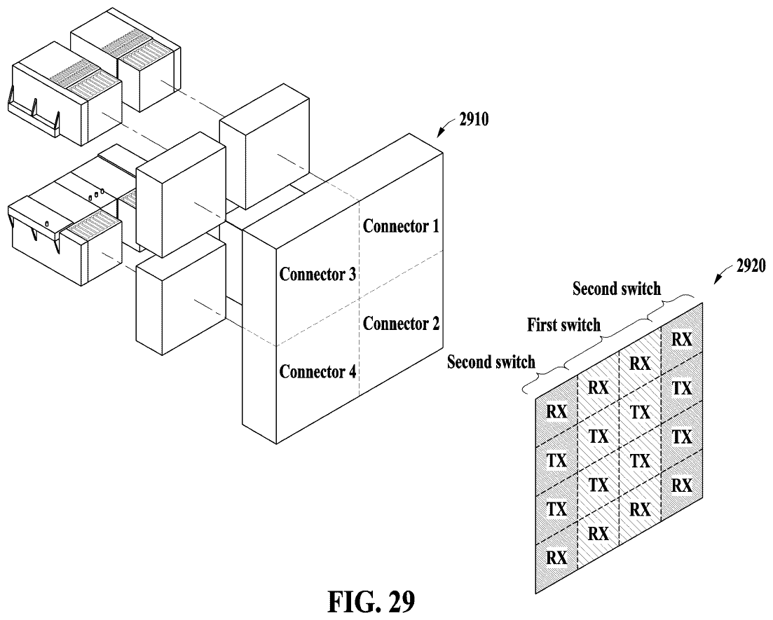

FIGS. 29 to 31 illustrate examples of mapping rules.

Referring to FIG. 29, connectors 2910 may be connected to switches and connectors of other computing boards according to mapping rules 2920. Mapping rules may indicate how each port of a connector is mapped to ports on switches and other connectors. The mapping rules 2920 may include a first mapping rule and a second mapping rule.

The first mapping rule may be a rule by which the connectors 2910 are connected to the switches. The first mapping rule may be determined based on the TX/RX pair and the switch pair described above.

The second mapping rule may be a rule by which the connectors 2910 are connected to connectors on other computing boards. The second mapping rule may be determined based on the board pair described above.

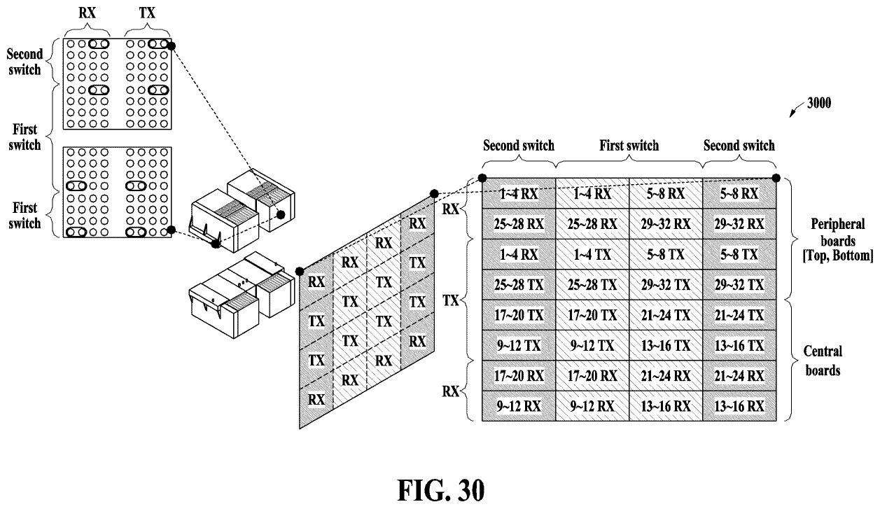

Referring to FIG. 30, an example of mapping rules 3000 showing the connection of connectors, switches, and other computing boards is illustrated. In the example of FIG. 30, the mapping rules 3000 for a rack containing 32 computing boards, with ports connecting to the switches and connectors of other computing boards is illustrated.

In the mapping rules 3000, the ports mapped to a first switch and a second switch may be arranged by separating a multi-layer board wiring between the switches and the connectors such that interference does not occur with each other. In the mapping rules 3000, the ports mapped to TX and RX may be arranged such that interference does not occur between TX and RX within the connector by considering the positions of TX and RX of the switches and the positions of TX and RX of the connector. The ports mapped to other computing boards in the rack may be arranged to distribute a via effect when connecting connectors on a second surface, taking into account that when connecting from a switch on a first surface of the computing board to a connector on the second surface, a via is to be passed through the computing board. For example, a plurality of computing boards stacked on a rack may be divided into three board groups (upper group, middle group, lower group) according to their positions, and a mapping rule may be determined such that the computing boards of the upper group and lower group are connected to the connectors located on the first surface. By connecting the computing boards of the upper group and the lower group to the connector located on the first surface, the electronic device of one or more embodiments may prevent a loss due to vias in cable connections with high path loss. A first cable may connect the upper group and the lower group, a second cable may connect the upper group and the middle group or the middle group and the lower group, and a third cable may connect computing boards within the same group. As used herein, for ease of description, the first cable may be referred to as a “long cable,” the second cable may be referred to as a “medium cable,” and the third cable may be referred to as a “short cable.”

For ease of description, in the mapping rules 3000, a port connected to the first switch is shown as a hatched area, and a port connected to the second switch is shown as a shaded area, but embodiments are not limited thereto. Central boards may be computing boards (e.g., computing boards in the middle group) within a predetermined range of an arrangement of computing boards in the rack, and peripheral boards may be computing boards (e.g., computing boards in the upper group and the lower group) outside the predetermined range. For example, when a rack contains 32 computing boards, the central board may represent computing boards 9-24, and the peripheral boards may represent computing boards 1-8 and 25-32.

Additionally, RX and TX illustrated in FIG. 30 may represent the receiver and transmitter for the connectors of other computing boards of the connector, respectively. Since the cable connection structure between the computing boards is directional for TX and RX, signals may be transmitted from TX to RX. Considering the location of the switches arranged in a first row or second row, the first switch may be connected to the second switch such that all paths are less than or equal to a determined path loss threshold. For example, the TX for the first switch on a predetermined computing board may be connected to the RX for the second switch on another computing board.

Additionally, for all-to-all connection between all computing boards, a port corresponding to a computing board receiving data on a computing board transmitting data may be connected to a port corresponding to a computing board transmitting data on a computing board receiving data. For example, a cable from a first computing board to a 32nd computing board may be connected to a port on the first computing board corresponding to the 32nd computing board and a port on the 32nd computing board corresponding to the first computing board.

All computing boards in the rack may be connected to have uniform path loss, but embodiments are not limited to the connection structure of the mapping rules 3000 illustrated in FIG. 30. For example, depending on embodiments, the mapping rules 3000 may cause the ports of a connector to be mapped to ports of a switch and other connectors in a random shuffling or interleaving manner.

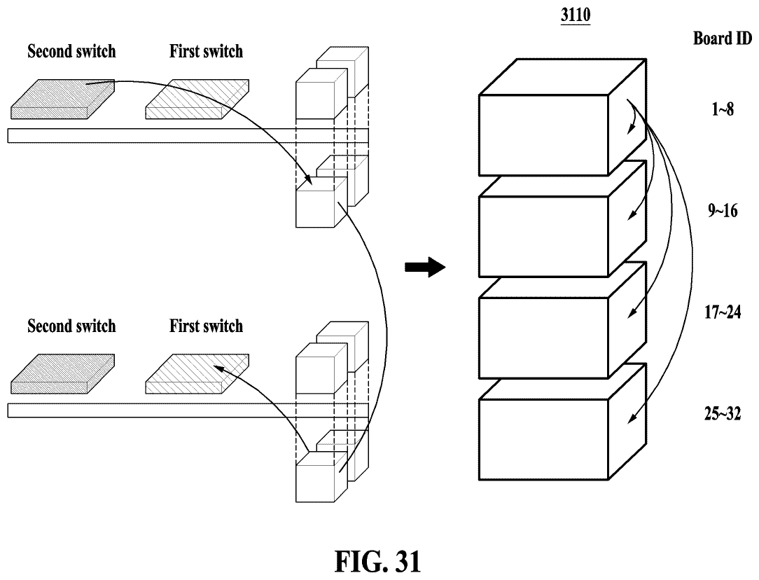

Referring to FIG. 31, an example in which switches are connected between computing boards within a rack 3110 according to mapping rules is illustrated.

In a wiring structure according to an example, when computing boards are connected, all computing boards stacked within the rack 3110 may be directly connected and connected in an all-to-all structure. However, there may be a difference in path length between computing boards that are spaced far apart and computing boards that are spaced relatively close together, which may lead to asymmetry in cable length. The mapping rules according to an example may reduce the asymmetry in cable lengths between computing boards by connecting connectors and switches in a partitioned network structure.

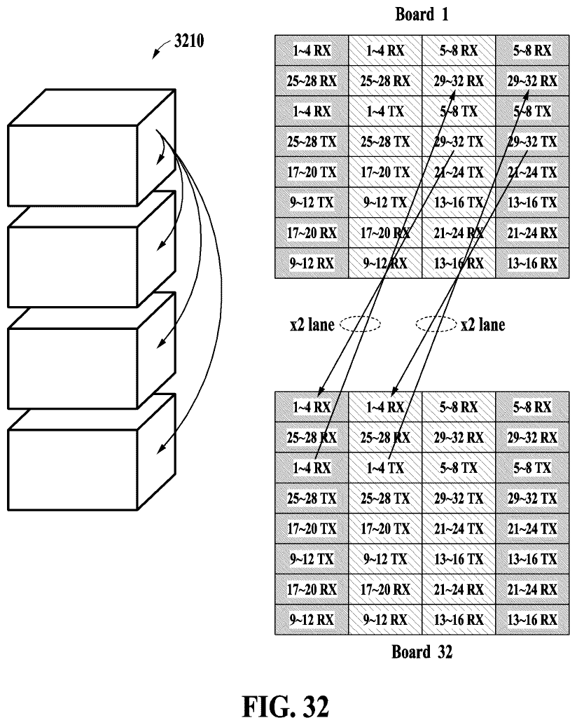

FIG. 32 illustrates an example of mapping rules.

Referring to FIG. 32, an example in which a 1st computing board and a 32nd computing board included in a rack 3210 are connected is illustrated.

In the example of FIG. 32, the ports described below may be connected to each other according to the mapping rules such that the 1st computing board and the 32nd computing board may be connected.
RX port mapped to a 1st switch of a 1st computing board and 29th to 32nd computing boards, and TX port mapped to a 2nd switch of a 32nd computing board and the 1st to 4th computing boards.
TX port mapped to the 1st switch of the 1st computing board and the 29th to 32nd computing boards, and RX port mapped to the 2nd switch and the 1st to 4th computing boards of the 32nd computing board.
RX port mapped to the 2nd switch of the 1st computing board and the 29th to 32nd computing boards, and TX port mapped to the 1st switch of the 32nd computing board and the 1st to 4th computing boards
TX port mapped to the 2nd switch of the 1st computing board and the 29th to 32nd computing boards, and RX port mapped to the 1st switch and the 1st to 4th computing boards of the 32nd computing board.

In the example of FIG. 32, the two computing boards may be connected in 4 lanes or 8 pairs through the cable connections.

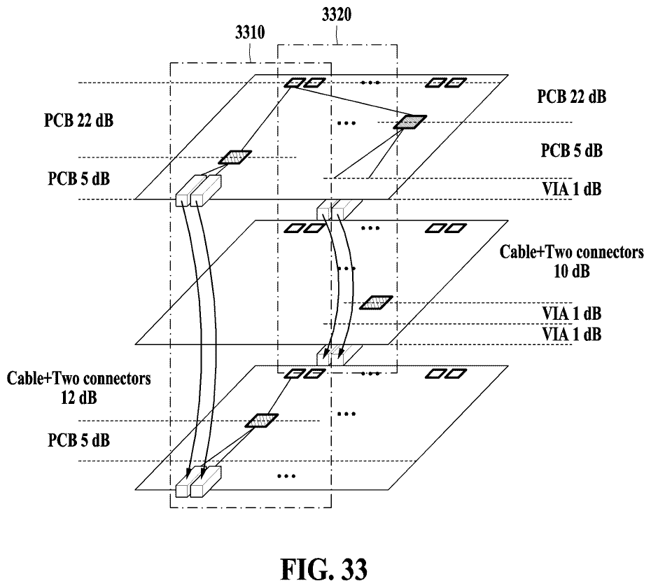

FIG. 33 illustrates an example of computing nodes being connected.

Referring to FIG. 33, an electronic device may provide uniform network performance for a path between computing devices within a predetermined loss range through an arrangement of switches, an arrangement of connectors, and a connection structure of cables.

In the example of FIG. 33, a path 3310 may be determined by a connection of a first switch-a connector arranged on a first surface-a first cable-a connector arranged on the first surface-a second switch, and a path 3320 may be determined by a connection of the second switch-a connector arranged on a second surface-a second cable-a connector arranged on the second surface-the first switch.

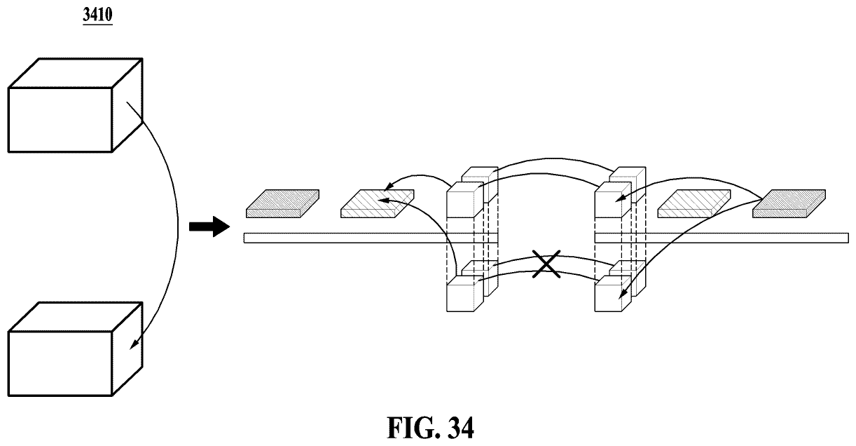

FIGS. 34 to 38 illustrate examples of switches being connected while taking path losses into account.

Referring to FIG. 34, an electronic device of one or more embodiments may increase the scale of a system by reducing path loss for connections with high path loss among connections between computing devices. For example, when a first switch has less loss than a second switch, a connector arranged on a first surface of a computing board has less loss than a connector arranged on a second surface, and a second cable and a third cable have less loss than a first cable, and when a cable loss size is dominant among the losses occurring in a path 3510, the total loss of the path 3510 may be maintained or reduced by reducing other losses. For example, the path loss along a cable length may be controlled with connections such as the following:
\textcircled{1} First switch—connector arranged on the first surface—first cable-connector arranged on the first surface—second switch
\textcircled{2} First switch—connector placed on the second surface—second cable or third cable—connector placed on the second surface-second switch

Referring to FIG. 34, a path 3410 according to the connection of \textcircled{1} is illustrated as an example.

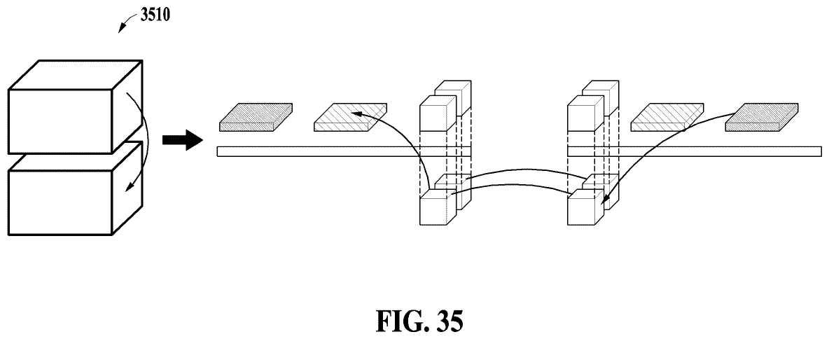

Referring to FIG. 35, the path 3510 according to the connection of (2) is illustrated as an example.

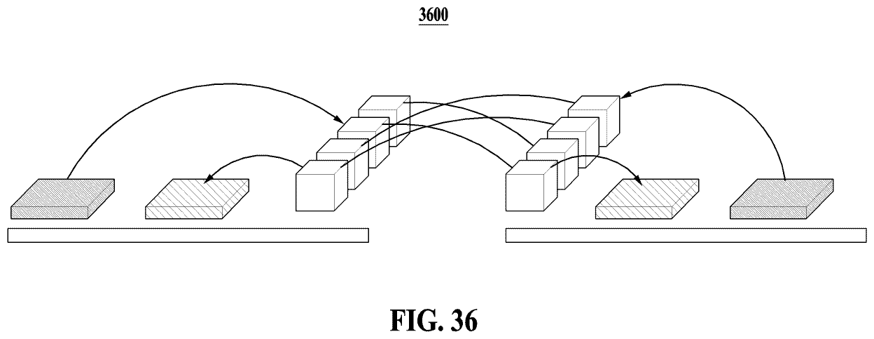

Referring to FIG. 36, an example of a connection 3600 between computing devices in a structure of a group of connectors arranged in a row is illustrated.

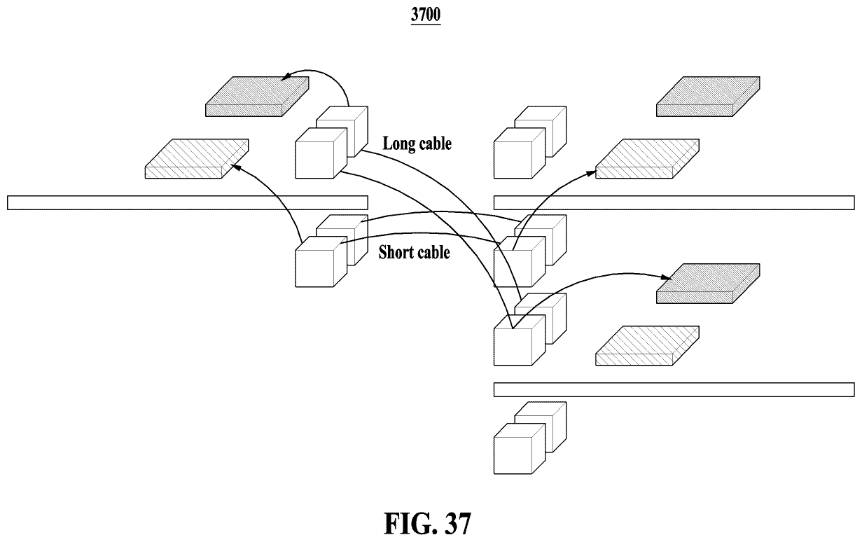

Referring to FIG. 37, an example of a connection 3700 between computing devices in a switch structure arranged in a row is illustrated.

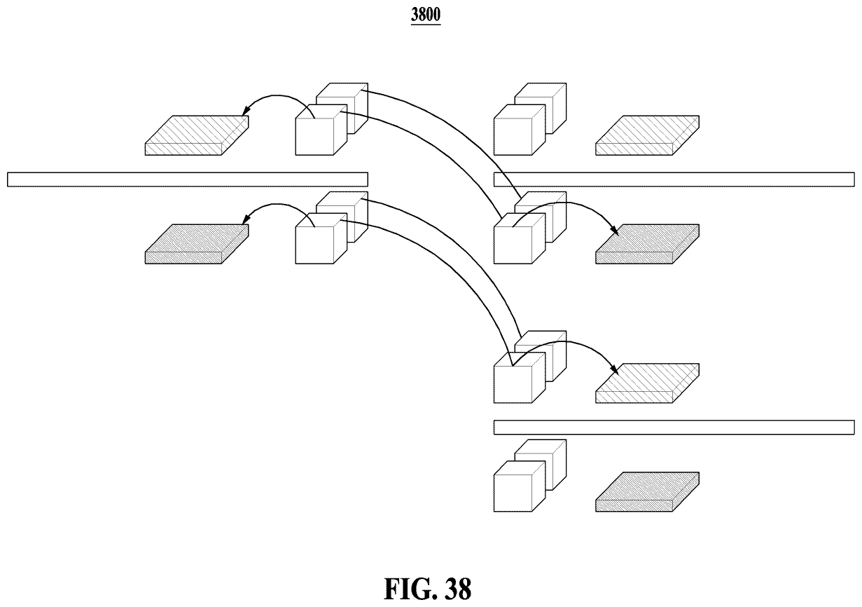

Referring to FIG. 38, an example of a connection 3800 between computing devices when the switches are arranged separately on the first and second surfaces of the computing board is illustrated.

The switches and connectors arranged on the second surface of the computing board may have the same path loss as the switches and connectors arranged on the first surface of the computing board. The switch structure may have the switches arranged separately on the first and second surfaces, such that distances between the switches and the connectors may be set to the same. Additionally, the wiring density between a switch arranged on the first surface and a connector arranged on the second surface may be eliminated, such that the path loss on the computing board may be configured symmetrically.

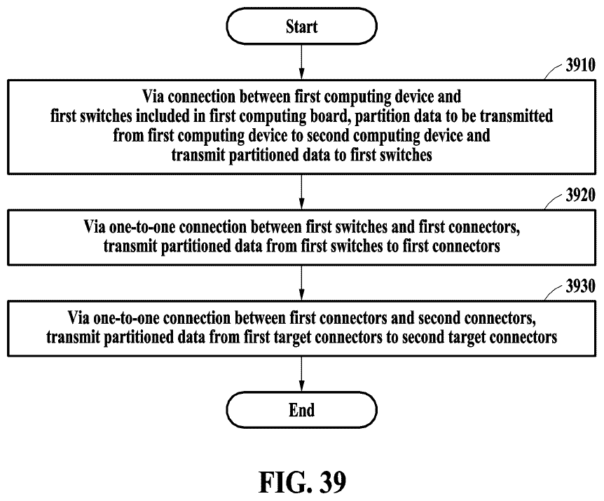

FIG. 39 illustrates an example of an operating method of an electronic device in a bundled connection structure.

In the following examples, operations may be performed sequentially, but not necessarily performed sequentially. For example, the order of the operations may be changed and at least two of the operations may be performed in parallel. Operations 3910 to 3930 may be performed by at least one component (e.g., a host) of the electronic device.

In operation 3910, the electronic device may, via a connection between a first computing device included in a first computing board and first switches included in the first computing board, partition data to be transmitted from the first computing device to a second computing device included in a second computing board and transmit the partitioned data to the first switches.

In operation 3920, the electronic device may, via a one-to-one connection between the first switches and first connectors included in the first computing board, transmit the partitioned data from the first switches to the first connectors.

In operation 3930, the electronic device may, via a one-to-one connection between the first connectors and second connectors included in the second computing board, transmit the partitioned data from the first target connectors to the second target connectors.

The second connectors may transmit the partitioned data to the second computing device via second switches included in the second computing board.

The descriptions provided with reference to FIGS. 1 to 38 may be applicable to each operation shown in FIG. 39, and thus, detailed descriptions thereof have been omitted.

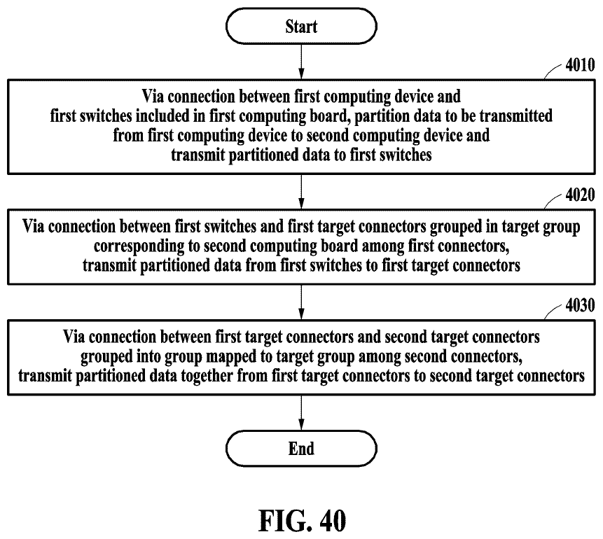

FIG. 40 illustrates an example of an operating method of an electronic device in a partitioned connection structure.

In the following examples, operations may be performed sequentially, but not necessarily performed sequentially. For example, the order of the operations may be changed and at least two of the operations may be performed in parallel. Operations 4010 to 4030 may be performed by at least one component (e.g., a host) of the electronic device.

In operation 4010, the electronic device may, via a connection between a first computing device included in a first computing board and the first switches included in the first computing board, partition data to be transmitted from the first computing device to a second computing device included in a second computing board and transmit the partitioned data to the first switches.

In operation 4020, the electronic device may, via a connection between the first switches and first target connectors grouped in a target group corresponding to the second computing board among the first connectors included in the first computing board, transmit the partitioned data from the first switches to the first target connectors.

In operation 4030, the electronic device may, via a connection between the first target connectors and second target connectors grouped into a group mapped to the target group among second connectors included in the second computing board, transmit the partitioned data together from the first target connectors to the second target connectors.

The second target connectors may transmit the partitioned data to the second computing device via second switches included in the second computing board. Each of the switches may be connected to each of the switches on second computing boards through the first connectors and the second connectors, and the switches included in the first computing board may not be directly connected to each other. One or more of the first connectors within the target group may be arranged on a first surface of the first computing board, the remaining connectors may be arranged on a second surface of the first computing board, and one or more of the switches connected to the connectors, that is, the first switches, may be arranged closer to the connectors on the first computing board than the remaining second switches. The first connectors may be connected to the second connectors arranged on one of the computing boards, based on a predetermined mapping rule that a distance between two computing boards among the computing boards is less than or equal to a predetermined threshold. A first switch among the switches may be connected to a switch arranged further away from the second connector than the other switches on the second computing board, and a second switch among the switches may be connected to a switch positioned closer to the second connector than the other switches on the second computing board. Based on a path loss of at least one of the switches, the first connectors, the second connectors, and cables connecting the connectors, the first computing device of one or more embodiments may be connected to the second computing device included in the second computing board such that a total path loss required is less than or equal to a predetermined threshold.

The descriptions provided with reference to FIGS. 1 to 39 may be applicable to each operation shown in FIG. 40, and thus, detailed descriptions thereof have been omitted.

The electronic devices, hosts, computing boards, computing devices, switches, networks, switch fabrics, horizontal networks, horizontal structures, parallel structures, nodes, connectors, cable slots, connector slots, bundled connection structures, partitioned connection structures, connections, computing device-switch connections, switch-connector connections, upper layer wirings, lower layer wirings, connector arrays, racks, busbars, electronic device 100, host 110, computing board 120, computing devices 123, switches 121, network 200, computing boards 210, 220, first computing device 211, second computing device 221, switch fabric 230, horizontal network 400, horizontal structure 410, parallel structure 420, computing device 401, computing device 402, horizontal network 500, horizontal network 600, horizontal network 700, nodes 710, switches 720, horizontal network 800, nodes 810, switches 820, connector 830, horizontal network 900, nodes 910, switches 920, computing board 1010, computing board 1020, cable slot 1015, cable slot 1025, network 1200, connector slots 1310, bundled connection structure 1410, partitioned connection structure 1420, group of connectors 1510, group of connectors 1520, connections 1610, 1620, and 1630, computing device-switch connections 1711, 1712, 1713, and 1714, switch-connector connections 1721, 1722, 1723, and 1724, switches 1811 and 1812, connectors 1821, 1822, 1823, and 1824, first switch 1911, second switch 1912, connectors 1921 and 1922, connectors 1923 and 1924, first switch 2111, second switch 2112, connectors 2121 and 2122, first switch 2211, second switch 2212, connector 2221, connector 2222, upper layer wiring 2310, lower layer wiring 2320, connector array 2400, connector arrays 2500, connector array 2510, rack 2600, busbar 2610, cable slots 2620, connectors 2910, rack 3110, rack 3210, connection 3600, connection 3700, and connection 3800 described herein, including descriptions with respect to respect to FIGS. 1-40, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-40 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An electronic device, comprising:
switches connected to computing devices included in a reference computing board; and
first connectors connected to the switches in the reference computing board and grouped into a plurality of groups,
wherein
among the first connectors, first target connectors grouped into a target group among the plurality of groups are connected to second target connectors grouped into a group mapped to the target group among second connectors included in another computing board mapped to the target group, and
one of the computing devices included in the reference computing board is connected to one of computing devices included in the other computing board via the switches, the first target connectors, and the second target connectors.

2. The electronic device of claim 1, wherein
each of the switches is connected to each switch on other computing boards via the first connectors and the second connectors, and
the switches included in the reference computing board are not directly connected to each other.

3. The electronic device of claim 1, wherein
one or more of the first target connectors are arranged on a first surface of the reference computing board,
remaining connectors of the first target connectors are arranged on a second surface of the reference computing board, and
among the switches, a first switch is arranged closer to the first connectors on the reference computing board than a remaining second switch.

4. The electronic device of claim 3, wherein the first connectors are connected to the second connectors included in the other computing board, based on a predetermined mapping rule that a distance between the reference computing board and the other computing board is less than or equal to a predetermined threshold.

5. The electronic device of claim 3, wherein
the first switch is connected to a switch arranged further away from the second connectors than other switches on the other computing board, and
the second switch is connected to a switch arranged closer to the second connectors than the other switches on the other computing board.

6. The electronic device of claim 1, wherein, based on a path loss of one or more of the switches, the first connectors, the second connectors, and cables connecting the connectors, the one of the computing devices included in the reference computing board is connected to the one of the computing devices included in the other computing board such that a total path loss between the one of the computing devices included in the reference computing board and the one of the computing devices included in the other computing board is less than or equal to a predetermined threshold.

7. The electronic device of claim 1, wherein wires connecting the switches and the computing devices, and/or wires connecting the switches and the first connectors, are determined as a high density interconnect (HDI) trace or a multi-layer board (MLB) trace depending on a path loss per wire length.

8. An electronic device, comprising:
switches connected to computing devices included in a reference computing board; and
first connectors connected to the switches in the reference computing board and grouped into a plurality of groups,
wherein
the first connectors grouped into the plurality of groups are connected to the second connectors included in another computing board in corresponding groups, and
one of the computing devices included in the reference computing board is connected to one of computing devices included in the other computing board via the switches, the first connectors, and the second connectors.

9. The electronic device of claim 8, wherein
each of the switches is connected to each switch on other computing boards via the first connectors and the second connectors, and
the switches included in the reference computing board are not directly connected to each other.

10. The electronic device of claim 8, wherein
one or more of the first connectors in the same group are arranged on a first surface of the reference computing board,
remaining connectors of the first connectors are arranged on a second surface of the reference computing board, and
among the switches connected to the first connectors, a first switch is arranged closer to the first connectors on the reference computing board than a remaining second switch.

11. The electronic device of claim 10, wherein the first connectors are connected to the second connectors included in the other computing board, based on a predetermined mapping rule that a distance between the reference computing board and the other computing board is less than or equal to a predetermined threshold.

12. The electronic device of claim 10, wherein
the first switch is connected to a switch arranged further away from the second connectors than other switches on the other computing board, and
the second switch is connected to a switch arranged closer to the second connectors than the other switches on the other computing board.

13. The electronic device of claim 8, wherein, based on a path loss of one or more of the switches, the first connectors, the second connectors, and cables connecting the connectors, the one of the computing devices included in the reference computing board is connected to the one of the computing devices included in the other computing board such that a total path loss between the one of the computing devices included in the reference computing board and the one of the computing devices included in the other computing board is less than or equal to a predetermined threshold.

14. The electronic device of claim 8, wherein
the first connectors are first target connectors grouped into a target group among the plurality of groups, and
the second connectors are second target connectors grouped into a group mapped to the target group.

15. A processor-implemented method comprising:
via a connection between a first computing device included in a first computing board and switches included in the first computing board, partitioning data to be transmitted from the first computing device to a second computing device included in a second computing board and transmitting the partitioned data to the switches;
via a connection between first target connectors grouped in a target group corresponding to the second computing board among first connectors included in the first computing board and the switches, transmitting the partitioned data from the switches to the first target connectors; and
via a connection between the first target connectors and second target connectors grouped into a group mapped to the target group among second connectors included in the second computing board, transmitting the partitioned data together from the first target connectors to the second target connectors,
wherein the second target connectors are configured to transmit the partitioned data to the second computing device via switches included in the second computing board.

16. The method of claim 15, wherein
each of the switches included in the first computing board is connected to each switch on second computing boards via the first connectors and the second connectors, and
the switches included in the first computing board are not directly connected to each other.

17. The method of claim 15, wherein
one or more of the first target connectors in the target group are arranged on a first surface of the first computing board,
remaining connectors of the first target connectors are arranged on a second surface of the first computing board, and
among the switches connected to the first target connectors, a first switch is arranged closer to the first target connectors on the first computing board than a remaining second switch.

18. The method of claim 17, wherein, the first connectors are connected to the second connectors included in the second computing board, based on a predetermined mapping rule that a distance between the first computing board and the second computing board is less than or equal to a predetermined threshold.

19. The method of claim 17, wherein
the first switch is connected to a switch arranged further away from the second connectors than the switches included in the second computing board, and
the second switch is connected to a switch arranged closer to the second connectors than the switches included in the second computing board.

20. The method of claim 15, wherein, based on a path loss of one or more of the switches, the first connectors, the second connectors, and cables connecting the connectors, the first computing device is connected to the second computing device included in the second computing board such that a total path loss between the first computing device and the second computing device is less than or equal to a predetermined threshold.
